(19) United States
(12) Patent Application Publication
(10) Pub. No.: US 2012/0015176 A1
(43) Pub. Date: Jan. 19, 2012

(54) BIOLAMINATE COMPOSITE ASSEMBLY AND RELATED METHOD

(76) Inventors: Michael J. Riebel, Mankato, MN (US); Milton Riebel, Mankato, MN (US); Ryan W. Riebel, North Mankato, MN (US)

(21) Appl. No.: 13/182,910

(22) Filed: Jul. 14, 2011

Related U.S. Application Data
(63) Continuation-in-part of application No. 13/019,060, filed on Feb. 1, 2011.
Application No. 13/019,060 is a continuation of application No. 12/410,018, filed on Mar. 24, 2009.
(60) Provisional application No. 61/038,971, filed on Mar. 24, 2008.
(60) Provisional application No. 61/364,298, filed on Jul. 14, 2010.
(60) Provisional application No. 61/364,193, filed on Jul. 14, 2010.
(60) Provisional application No. 61/364,181, filed on Jul. 14, 2010.
(60) Provisional application No. 61/364,189, filed on Jul. 14, 2010.
(60) Provisional application No. 61/364,301, filed on Jul. 14, 2010.
(60) Provisional application No. 61/364,366, filed on Jul. 14, 2010.
(60) Provisional application No. 61/364,345, filed on Jul. 14, 2010.
(60) Provisional application No. 61/479,140, filed on Apr. 26, 2011.

(51) Int. Cl. B32B 21/08; B32B 9/04; B32B 27/10; B32B 25/00; B32B 27/36; B32B 27/32

(52) U.S. Cl. 428/323; 428/480; 428/521; 428/532; 428/537.1; 428/537.5; 428/492; 428/411.1

(57) ABSTRACT

Embodiments of the invention relate to a biolaminate composite assembly, including one or more biolaminate layers, a non-plastic rigid substrate and an adhesive layer in contact with the substrate and the one or more biolaminate layers. The substrate is laminated or formed to the one or more biolaminate layers. Embodiments also relate to methods of making a biolaminate composite assembly.

### CROSS-REFERENCE TO RELATED APPLICATIONS

This application is a Continuation-in-Part of U.S. patent application Ser. No. 13/019,060, filed Feb. 1, 2011, entitled “Biolaminate Composite Assembly and Related Methods,” which is a Continuation of U.S. patent application Ser. No. 12/410,018, filed Mar. 24, 2009, which claims priority to U.S. Provisional Application No. 61/038,971, filed Mar. 24, 2008. This application also claims priority to U.S. Provisional Application Nos. 61/364,298 filed Jul. 14, 2010 (atty. ref. 222923/US); 61/364,189 filed Jul. 14, 2010 (atty. ref. 222076/US); 61/364,181 filed Jul. 14, 2010 (atty. ref. 222075/US); 61/364,345 filed Jul. 14,2010 (atty. ref. 222919/US); 61/364,366 filed Jul. 14, 2010 (atty. ref. 222918/US); 61/364,301 filed Jul. 14, 2010 (atty. ref. 222925/US); 61/364,193 filed Jul. 14, 2010 (atty. ref. 222928/US); and 61/479,140 filed Apr. 26, 2011 (atty. ref. 222386/US). The contents of all above-mentioned applications are hereby incorporated in their entirety by reference.

### BACKGROUND

The environmental movement in the United States and abroad continues to grow into a mainstream concern with growing demand for environmentally friendlier (“green”) products and programs to remove hazardous materials from the residential and workplace environment. PVC (polyvinylchloride) and formaldehyde-based laminate worksurfaces and components are now being removed from many applications due to their toxic nature. Many businesses and organizations are taking aggressive action to remove PVC and formaldehyde-based products from the interior workplace and product fines.

The demand continues to grow for “green” products to replace petrochemical plastics and hazardous polymer. This demand is driven by environmental awareness and by the architectural and building communities based on making interior environments healthier. Materials commonly used in many architectural, institutional, and commercial applications for vertical and horizontal surfacing products are primarily derived from PVC and melamine formaldehyde laminates. With growing concerns over the usage of hazardous PVC and formaldehyde in interior applications, there is a need for environmentally friendly alternatives that meet both performance and economic requirements.

Formaldehyde has created serious concerns over interior air quality. Products such as particleboard and high pressure laminates use substantial amounts of formaldehyde in their resinous makeup. In many cases, the formaldehyde is not removed completely from the product and is introduced into interior public or residential closed spaces and may off-gas for an extended time. Formaldehyde has been linked to many health problems and is classified as a known carcinogen. Major corporations have now made public policy statements that they are to remove PVC and formaldehyde from their places of work. Japan has put in legislation creating strict policies inhibiting the usage of PVC and formaldehyde containing products. Similar legislation has been enacted in Europe.

PVC has been classified by many groups as a “poison plastic”. Over 7 billion pounds of PVC is discarded every year. The production of PVC requires the manufacturing of raw chemicals, including highly polluting chlorine, and cancer-causing vinyl chloride monomer. Communities surrounding PVC chemical facilities suffer from serious toxic chemical pollution of their ground water supply, surface water and air. PVC also requires a large amount of toxic additives resulting in elevated human exposure to phthalates, lead, cadmium tin and other toxic chemicals. PVC in interior applications releases these toxic substances as volatile organic compounds (VOCs) in buildings. Deadly dioxins and hydrochloric acids are released when PVC burns or is incinerated.

The vast majority of vertical or horizontal decorative surfacing materials are high pressure laminates and thermofoil PVC. Work surfaces, tables, desktops, and many other work surfaces glue a thin high pressure laminate (HPL) (typically 0.050 inch thickness to a wood particleboard adhered with urea formaldehyde glues). Over the last decade, many kitchen cabinets were produced by cutting a medium density fiberboard containing phenol formaldehyde glues into a door shape. A thin PVC sheet or thermofoil was heated and pressed onto this three dimensional shaped door using a membrane press. The resultant door was already finished and resistant to water, but contained high amounts of chlorine. If the cabinets were burned, the off-gassing may create a deadly hydrochloric acid gas for fire fighters or people who may not escape the fire.

Currently, virtually all worksurfaces found in commercial, institutional and even residential applications are based on harmful petrochemically derived products. Most commonly high pressure laminates are commonly used in office desks, tables and countertops. These are produced using dangerous formaldehyde based materials that off-gas even after installation. PVC thermofoils are also commonly used in which the harmful PVC creates a myriad of issues. Many organizations, companies and governments have limited or even restricted the usage of these materials, but little has been found that can be an effective and competitive environmental replacement for such product.

Biobased material is seen as an ideal solution in the architectural, institutional, commercial and even residential markets. Despite this, few products have entered the market as a direct replacement for PVC thermofoils used in surfacing and formaldehyde-based laminates. Biorenewable materials are preferred over petrochemically derived plastic products. Bioplastics have been commonly used for various packaging film applications. Primarily PLA (polylactic acid) has been the most commercially successful of these bioplastics. PLA is a hard brittle plastic that is highly mobile or quickly turns into a liquid under open flame conditions. In addition, PLA may not be easily extruded into profile shapes due to its high melt index and unique rheology. Most all of current PLA products are based on creating biodegradability. As one can appreciate, however, it is not always desirable that products in long term commercial applications be biodegradable, even where biorenewability is desired.

PVC has come under attack by many global groups due to its environmentally hazardous nature and makeup. Currently it has been difficult to create commercial environmentally friendly alternative products to replace PVC. Some other type of petrochemical plastics are trying to accomplish this, but are only slightly improved in regards to their environmental nature. Biobased products provide a solution for PVC being based on biorenewable materials and are free of hazardous chemicals, plasticizers, and additives. Flexible PVC is used in many applications with its primary application in decorative flexible plastic products. Signage, vinyl wall paper and upholstery are some of the largest flexible PVC sheet applications that are commonly used in indoor applications. Designers and Architects designing indoor furnishing are especially concerned over indoor air quality and promoting the usage of environmentally friendly materials. The US Government also agrees that “biopreferred” products are a good environmental solution and has certified other agricultural material products as biopreferred for green building applications.

Materials for signage are typically very flexible PVC loaded with hazardous chemical plasticizers. The flexibility is needed for banners, mounting on curved surfaces, and allows the ability to be ran through large format inkjet printing systems. Secondly, most inks used in signage are solvent based also using harmful chemicals that can emit hazardous fumes during production and within the final application.

Profile wrapped components have been typically produced using various forms of foamed plastics or wood/agrifiber composites that are machined into specific forms and can include a thin foil wrapped surface that is used for functional or decorative needs. Profile linear wrapped millwork and components are typically used for a myriad of applications including:

Window components

Door Jams

Door components

Laminate flooring

Architectural Millwork

Siding

Composite Decking

Wood plastic extrusion has been commercialized over the past decade as a replacement for wood in exterior applications, primarily decking and window components. Currently they are simple colors and do not have a high degree of aesthetic value looking like plastic with chunks of wood. Typically wood plastic composites use polyethylene, polypropylene, or PVC as the binding plastic in combination with wood to produce these products. In some cases these composite have a coextrusion of a solid plastic on the outside creating a shell of solid color for UV protection and to hide the wood chunks making it slightly more aesthetically pleasing.

“Green” products have long been desired and are coming into the mainstream, but in most cases biomaterials or “green” solutions have come at a high price and typically do not meet the required performance standards. In some cases, people or companies will pay slightly more for a “green” product, but in reality, a “green” product needs to meet performance while being competitive in price. Being “green” is important, but the ability to supply performance at a competitive price is important to commercialization of “green” technologies. It is important that the materials and products within this environment are not harmful to overall health and provide a clean, VOC-free environment. PVC and its additives, along with formaldehyde from laminates and some particleboards, release harmful VOCs into the work place. These VOCs have been classified as potential carcinogens, creating a higher risk of cancer.

Although “green” biodegradable packing materials are moving the global community towards better environment practices, there exists a strong market demand for non-biodegradable biorenewable materials for more permanent applications to replace hazardous or petrochemically-derived products.

With growing environmental concerns and demand for “greener” products a need has been established for materials that are derived from rapidly renewable resources and that replace hazardous and non-renewable petrochemical products. In addition, there is a need to also have a high level of performance and be competitive in costs with current building, signage, decorative sheet, and laminate materials in the market.

Over the past decade, bioplastics have come into the mainstream market specifically targeted at biodegradable plastics applications. The practical usage of biopolymers such as PLA and PHA have been limited to films and blow molded bottles primarily due to the market demand and technical limitations of rheology of these forms of bioplastics. Bioplastics such as PLA have unique flow dynamics, lower heat distortion levels, polar nature, and unique overall rheological properties.

Methods known in the art for making final laminates include Low Pressure Laminate (LPL), High Pressure Laminate (HPL) and Continuous Pressure Laminate (CPL) processes. Low pressure is most often used with card-board or particle, board, whereas high pressure generally is used with the so-called kraft papers. The sheets or products resulting from the HPL process are generally not self-supportive. They are often bonded, with a suitable adhesive or glue, to a rigid substrate such as particle board or medium density fiber board (MDF). In a continuous pressure laminate process, papers may be fed from a role into a continuous belt press.

Traditional production suffers from drawbacks which are not easily overcome. One problem is that the laminates made in the high pressures or continuous process are so hard, that it is difficult to bend or ‘post-form’ these sheets. At present, post-forming characteristics are often achieved by either incorporating expensive modifiers like benzoguanamine or acetoguanamine, or by making melamine-formaldehyde resins at elevated pressure, allowing more melamine to react with formaldehyde. The latter process is relatively expensive, and requires pressure vessels. Yet, it may be advantageous if, while keeping the abrasion resistance and chemical resistance properties, the HPL or CPL sheets would be bendable, so they could be made to cover a substrate not only on one side, but in one process step. Another drawback of traditional laminates is the use of formaldehyde, which is known to be a toxic chemical. The resin used to impregnate traditional paper may be a formaldehyde-melamine resin. After curing, the laminate may still release some formaldehyde, which may cause environmental concerns.

### SUMMARY

Embodiments of the invention relate to a biolaminate composite assembly, including one or more biolaminate layers, a non-plastic rigid substrate and an adhesive layer in contact with the substrate and the one or more biolaminate layers. The substrate is laminated or formed to the one or more biolaminate layers. Embodiments also relate to methods of making a biolaminate composite assembly.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a cross-sectional view of a biolaminate composite assembly, according to some embodiments.

FIG. 2 illustrates a block flow diagram of a method of making a biolaminate composite assembly, according to some embodiments.

FIG. 3 illustrates an expanded view of a biolaminate composite assembly, according to some embodiments.

FIG. 4 illustrates an expanded view of a biolaminate composite assembly, according to some embodiments.

FIG. 5 illustrates an expanded view of a biolaminate composite assembly, according to some embodiments.

FIG. 6 illustrates an expanded view of a biolaminate composite assembly, according to some embodiments.

FIG. 7 illustrates a cross-sectional view of a veneer biolaminate composite assembly, according to some embodiments.

FIG. 8 illustrates a cross-sectional view of a biolaminate composite assembly including a high performance surface layer, according to some embodiments.

### DEFINITIONS

As used herein, “additive” refers to a material or substance included in a biolaminate layer or biolaminate composite assembly that provides a functional purpose or a decorative/aesthetic purpose. An example of a functional additive would be a Eire retardant, impact modifier, antimicrobial, UV stabilizer, processing aid, plasticizer, filler, mineral particle for hardness, and other forms of standard plastic or bioplastic additives. A decorative additive would be a colorant, fiber, particle, dye. Additives may also perform both functional and decorative purposes. Additives may be implemented as part of one or more biolaminate layers or as one or more separate layers in a biolaminate composite assembly.

As used herein, “adhesive layer” or “adhesive” refers to a substance that bonds two or more layers in a biolaminate layer or biolaminate composite assembly. Adhesives may include glues. Examples of adhesives include urethane, PVC, PVA, PUR, EVA and other forms of cold press or hot pressed laminating adhesives and methods. The biolaminate and laminates in general are typically adhered to a non plastics or wood/agrifiber composite material using various glues and laminating processes. Glues, such as contact cement, PVA, urethanes, hot melts and other forms of adhesives are commonly used in HPL (high pressure lamination). Although many of these glues may optionally work for embodiments of the invention, low or no VOC-containing glues are preferable in the adhesive system that may be either hot pressed, rolled or cold pressed processes to adhere the biolaminate layer to a substrate.

As used herein, “bioink” refers to a non-petroleum based ink. A bioink may be made of organic material, for example.

As used herein, “biolaminate layers” or “biolaminate” refers to one or more thin layers in contact with a non-plastic rigid substrate, including materials that are derived from natural or biological components. The biolaminate layer may be a multi-layer, such as including multiple layers. One form of biolaminate is made up of a bioplastic or bio-co-polymer, such as PLA (polylactic acid). A biocopolymer, including PLA and other biopolymers, may be used within this invention to create a biolaminate. Biolaminate layers may refer to one or more thin layers including over 50% PLA in combination with optional additives, colorants, fillers, reinforcements, minerals, and other inputs to create a biolaminate composite assembly.

As used herein, “biopolymer” or “bioplastic” refers to a polymer derived from a natural source, such as a living organism. A biopolymer may also be a combination of such polymers, such as in a mixture or as a copolymer, for example. A biopolymer may be a polymer derived from a natural source, such as a living organism. A biopolymer may be a sugar, for example. Polylactic acid (PLA) and polyhydroxyalkanoate (PHA) may be examples of a biopolymer. Biopolymers may be derived from corn or soybeans, for example. A biopolymer may be a co-polymer or a mixture of more than one biopolymer, such as a mixture of PLA and PHA, for example. Other forms of biopolymers included within the embodiments of the invention (and derived from renewable resources) are polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

As used herein, “contacting” refers to physically, mechanically, chemically or electrically bringing two or more substances together or within close proximity. Contacting may be mixing or dry blending, for example.

As used herein, “forming” or “formed” refers to contacting two or more layers of material, such that an adherent semi-permanent or permanent bond is formed. Examples of forming include thermoforming, vacuum forming, linear forming, profile wrapping or a combination thereof.

As used herein, “heating” refers to increasing the molecular or kinetic energy of a substance, so as to raise its temperature.

As used herein, “laminate” or laminating” refers to contacting two or more layers of material using heat and/or pressure to form a single assembly or multilayer. Laminating may be accomplished with the use of an adhesive between the layers or by thermally fusing without the use of an adhesive, for example.

As used herein, “mixture” refers to a composition of two or more substances that are not chemically combined with each other and are capable of being separated.

As used herein, “non-biodegradable” refers to a substance that is non-biodegradable for a significant amount of time. A non-biodegradable material may not substantially degrade after about 5 years, after about 10 years, after about 20 years or after about 30 years, for example.

As used herein, “non-plastic rigid substrate” refers to wood, wood plastic, agrifiber, or mineral fiber composite panel primarily consisting of a particle, fiber, flake, strand or layer that is thermally pressed with a small amount of resin to produce a panel of sufficient strength for furniture and other building products requirements. A non-plastic rigid substrate may include some plastic, but include non-plastic materials, such as a wood or agrifiber plastic composite in an extruded or compressed sheet form. The non plastic rigid substrate may be a VOC-free particle board or MDF (medium density fiberboard) and preferably derived from rapidly renewable resources such as wheat straw or other biofiber or agricultural based fibers. Other non-plastic rigid substrates may include metal, wood particleboard, agrifiber particleboard, plywood, OSB (orientated strand board), gypsum board, sheet rock, hardboard (such as Masonite), cement or cement board and other rigid substrates. Non-plastic rigid substrates may include paper-based boards, cellulosic substrates (or other organic fibers), cellulose paper composites, multilayer cellulose glue composites, wood veneers, bamboo or recycled paper substrates. Examples of agrifiber particleboard include wheatboard such as MicroStrand produced by Environ Biocomposites Inc. Materials such as particleboard, medium density fiberboard, high density fiberboard, plywood, and OSB are commonly used composite building panels that provide a good substrate for high pressure laminates. Due to environmental pressures many of the wood composite panels that in the past were glued with formaldehyde based resins, such as urea form and phenol form, are being replaced with low or no VOC glues in the forms of urethane or methyl diisocyanide. Over the past decade, concerns over wood supplies have spurred the development of new fiber panels from more rapidly renewable resources including many agrifibers such as wheat straw, rice straw and other cereal grain straws.

As used herein “PLA” or “polylactic acid” refers to a thermoplastic polyester derived from field corn of 2-hydroxy lactate (lactic acid) or lactide. The formula of the subunit is:—[O—CH(CH₃)—CO]— The alpha-carbon of the monomer is optically active (L-configuration). The polylactic acid-based polymer is typically selected from the group consisting of D-polylactic acid, L-polylactic acid, D,L-polylactic acid, meso-polylactic acid, and any combination of D-polylactic acid, L-polylactic acid, D,L-polylactic acid and meso-polylactic acid. In one embodiment, the polylactic acid-based material includes predominantly PLLA (poly-L-Lactic acid). In one embodiment, the number average molecular weight is about 140,000, although a workable range for the polymer is between about 15,000 and about 300,000.

As used herein, “thermoforming” may refer to forming with the use of heat. Thermoforming may include the step of positioning a film or layer over the surface of a shaped substrate by means of a membrane press using heat and a bladder that presses and forms the film or layer over a complex three dimensional shape or two or more surfaces of a substrate. A thermally activated adhesive may initially be applied to the three dimensional substrate prior to heat forming the thin film or layer onto the surface. Thus the heat and pressure both form the layer onto the substrate shape and activate the adhesive layer at the same time.

### DETAILED DESCRIPTION

The following detailed description includes references to the accompanying drawings, which form a pan of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### INTRODUCTION

A biolaminate composite is provided. The biolaminate composite is flexible and 3D formable. Generally, the biolaminate composite comprises one or more biolaminate layers with at least one of the biolaminate layers compromising polylactic acid. In some embodiments, the at least one biolaminate layer may further comprise a natural wax such as soy wax. The one or more biolaminate layers may be formable, including 3-D formable, over a rigid non-plastic substrate to form a biolaminate composite assembly. Embodiments of the present invention describe a biolaminate derived from bioplastic, biocopolymer or biocomposites products, assemblies, and systems that provide a biosolution system to replace formaldehyde-based laminates and PVC products. In addition, embodiments of the invention provide an economically competitive solution to large commodity products.

A biocomposite substrate is further provided. Such biocomposite substrate may be three dimensional and may have a functional and/or decorate biolaminate surface. The biocomposite substrate may be particularly useful for profile linear wrapped millwork and components. The biocomposite substrates may be designed to be non-biodegradable.

Various embodiments of biolamiantes are provided that exhibit differing properties. In some embodiments, at least one of the biolaminate layers may include a plastic and a mineral and be suitable for use as a wear layer. In some embodiments, polyether ether ketone (PEEK) may be used in a surface wear layer. In other embodiments, two cellulose layers may be provided with the polylactic acid layer being provided therebetween. In other embodiments, an intumescent layer may be e provided in the biolaminate composite such that the composite exhibits fire retardant properties.

Embodiments relate to a product and methods for making a biolaminate assembly utilizing a saturated or resin impregnated paper layer, in particular a decorative surfacing laminate layer. The layer may include at least one cured layer of a polylactic or lactic acid saturated paper. The top or surface layer may include a decorative printed or colored paper. In another example, melamine-formaldehyde resin impregnated papers may be put on top of a stack of phenol-formaldehyde resin impregnated papers and subsequently cured. Generally, such biolaminate assembly may include a first cellulosic layer and a second cellulosic layer. A first bio-based polymer, such as PLA, may be provided between the first cellulosic layer and the second cellulsoic layers. Fusing of the first cellulosic layer, the first bio-based polymer, and the second cellulosic layer may impregnate the cellulosic layers with the first bio-based polymer substantially throughout the cellulosic layers.

Some embodiments may be formed as a biocorrugated system for use to replace building materials. Corrugation may be provided by forming a corrugated bioplastic core body to which further layers may be laminated.

Some embodiments relate to a biolaminate that may be profile wrapped over a substrate. Three-dimensional substrates are further provided for such wrapping.

In some embodiments, a decorative biolaminate composite may be provided. The decorative biolaminate may have a natural three dimensional depth of field as compared to PVC thermofoils or high pressure laminates based on the semitransparent nature of the biopolymers providing unique aesthetic and similar performance to that of other surfacing materials. In some embodiments, a latex paint layer may be incorporated into a biolaminate to provide efficient color matching for decorative purposes.

In some embodiments, various forms of aesthetic multicolored biolaminate assemblies may be formed of a biopolymer matrix resin and novel biocomposite random particles to create a wider range of aesthetics and a three dimensional appearance. The resultant sheet product has the natural appearance of natural granite and can be used in a myriad of building applications where a high aesthetic value and environmental properties are desired. More so, embodiments are 100% biobased with the ability to replace hazardous PVC thermofoils and formaldehyde-based high pressure laminates to provide a biosolution for these problematic products.

In some embodiments, a fire retardant biolaminate composite assembly is provided and may include a biolaminate layer and an intumescent layer and may have good char and low flame spread with minimal smoke generation. The biolaminate layer may comprise a PLA sub-layer and may include a fire retardant. The intumescent layer may comprise an intumescent material that swells as a result of heat exposure.

Further, a biosolution option is provided that is derived from rapidly renewable agricultural materials and designed for longer term applications and products typically used in interior applications where concerns over clean air and encouragement of environmentally friendly products are heightened.

Embodiments of this invention use unique bioplastics in combination with optional lower cost bioadditives that allow faster processing than conventional PVC and laminates and allow the products to be sold competitively with PVC thermofoils and high pressure laminates while being produced from rapidly renewable resources and providing no VOC contribution to the interior environment.

Generally, embodiments of the biolaminate composite may relate to a biolaminate composite assembly and/or a biolaminate surface system. Such biolaminate surface system may comprise a bioplastic, bio-copolymer, and biocomposite system in the form of a biolaminate layer that is laminated or thermoformed to a rigid non-plastic substrate by means of a glue line or adhesive layer. The biolaminate system also may include matching profile extrusion support products derived from the same composition and processing method.

Thus, a biolaminate composite assembly is described including one or more biolaminate layers that are adhered by means of laminating or thermoforming onto a non-plastic rigid substrate. The resultant biolaminate composite assembly is designed to be used for desktops, tabletops, worksurfaces, wall panels, wall coverings, cabinet doors, millwork, and other decorative laminated products. The biolaminate surface layer can be contacted with various nonplastic substrates by means of thermoforming for three dimensional components or flat laminated. The biolaminate layer may include one or more layers of a biopolymer, biocopolymer, biocomposite materials or a combination thereof. The biopolymer or modified biopolymer may include primarily a PLA or PHA or blend thereof. The biolaminate layer may include a biocopolymer wherein the biocopolymer includes an additional biopolymer or bioplastic or a petrochemical based plastic or recycled plastic. The biolaminate layer may include a biocomposite wherein a biopolymer is blended with various fillers, reinforcement, functional additives, fire retardants, and other such materials for aesthetic or functional needs.

In some embodiments, a biosurf biolaminate is integrated to various plastic or plastic fiber composite products to produce an environmentally friendly group of linear building components. The goal of this technology is the development of biobased components that can replace hazardous and petrochemical products with a rapidly renewable solution. Forms of these unique substrates can be processed in either linear form using profile extrusion processing or in final molded 3D shapes. 3D molded shapes are produced using similar compositions, but use specific press and mold technology to press a final 3D shapes such as passage doors, table tops, worksurfaces, store fixture components, and cabinet doors.

Composite Assembly

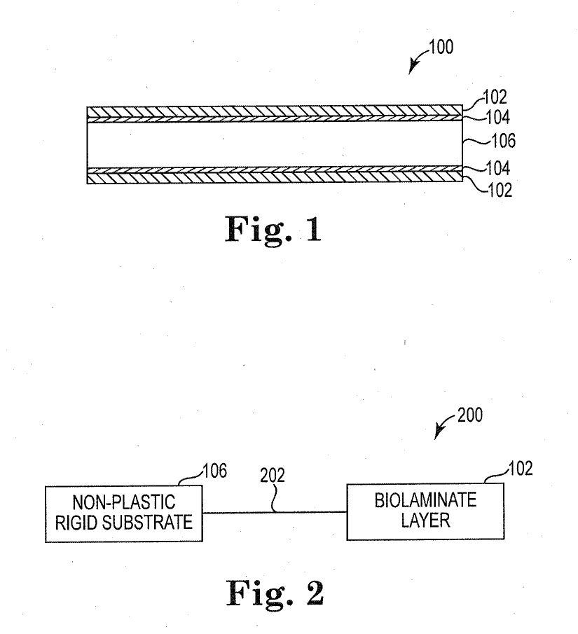

Referring to FIG. 1, a cross-sectional view 100 of a biolaminate composite assembly is shown, according to some embodiments. A non-plastic rigid substrate 106 may be in contact with an adhesive layer 104. The adhesive layer 104 may be in contact with one or more biolaminate layers 102. The non-plastic rigid substrate 106 may also be in contact with the layers 102, for example. A biolaminate layer 102 may include multiple layers.

Accordingly, the composite assembly may include a biolaminate layer and one or more other layers. The one more other layers may also be biolaminate layers. Some possible embodiments for these layers are described below. It is to be appreciated that while these layers may be discussed as separate layers from the biolaminate layer, the components or functionality of these layers may alternatively be provided in the biolaminate layer.

Embodiments of the invention may also includes multilayering of various biopolymers and/or integration with various petrochemical film layers for differing functional performance, although it may be most preferred to have all biopolymers. Embodiments of the present invention include thin film top layers made of Teflon, PEEK, PET, or combinations thereof and other higher temperature polymers as a top layer to impart higher heat resistance surfaces for such applications as kitchen counters.

Embodiments of the invention also include single or multiple layers of biopolymer films wherein individual films may be in a range of thicknesses from about 0.001″ to slightly over about 0.050″ and the final biolaminate may range from a thickness of about 0.001″ to about 0.125″ in thickness.

Biolaminate Layer

At least one biolaminate layer of the biolaminate composite assembly may include primarily a biopolymer including PLA, PHA or similar biopolymers.

The biopolymer, biocopolymer and biolaminate (or biolaminate layer or biolaminate composite assembly) may include one or more additives. Suitable additives include one or more of a dye, pigment, colorant, hydrolyzing agent, plasticizer, filler, extender, preservative, antioxidants, nucleating agent, antistatic agent, biocide, fungicide, fire retardant, heat stabilizer, light stabilizer, conductive material, water, oil, lubricant, impact modifier, coupling agent, crosslinking agent, blowing or foaming agent, reclaimed or recycled plastic, and the like, or mixtures thereof. In certain embodiments, additives may tailor properties of the biolaminate composite assembly for end applications. In one embodiment, the biopolymer may optionally include about 1 to about 20 wt-% of an additive or additives. Other additives may include other forms of synthetic plastics or recycled plastics such as polyethylene, polypropylene, EVA, PET, polycarbonate, and other plastics to enhance performance and add recycled content if desired or required. In one embodiment, the biolaminate layer may comprise 100% biorenewable biopolymer. Binders may be added to the biolaminate layer, such as EVA.

Additives may be present in the at least one biolaminate layer comprising PLA or similar biopolymer or may be provided in a separate layer within the composite assembly. Such additives may be functional or decorative, for example. Any discussion of such additives as present within the biolaminate layer or as provided in a separate layer is intended for the purposes of illustration only and it is to be appreciated that such discussion may equally apply to the other embodiment.

Bioplasticizers, biolubricants, fire retardants, decorative and functional fibers, decorative and functional fillers, colorant systems and surface textures may be integrated into a bioplastic, biocopolymer, or biocomposite (as part of the biolaminate layer or layers or assembly) producing an extrudable material that may be formed into a biolaminate sheet and matching profile extrusion components. For example, the biolaminate layer may include about 50% to about 95% polylactic acid polymer from corn or other natural materials in combination with a bioplasticizer/biolubricant and other additives.

The biolaminate layer may include a biopolymer such as PLA blended with plasticizers to form a flexible biolaminate sheet that also can be printed on the surface or reversed printed on a clear flexible biolaminate. The flexible biolaminate can be laminated onto a sheet rock wall as a replacement for PVC vinyl wall covering. In this case, an optional nonwoven material may be coextruded onto the backside of the flexible biolaminate to add additional strength for such application. The flexibility of the biolaminate layer may be comparable to that of a PVC sheet.

The biolaminate layer of the biolaminate composite assembly may also include a plasticizer or impact modifier to produce a more flexible biolaminate or softer surface biolaminate layer. Preferably, the plasticizer has a boiling point of at least 150° C. Examples of plasticizers that may be used include, but are not limited to, glycerine, polyglycerol, glycerol, polyethylene glycol, ethylene glycol, propylene glycol, sorbitol, mannitol, and their acetate, ethoxylate, or propoxylate derivatives, and mixtures thereof. Specific plasticizers that may be used include, but are not limited to, ethylene or propylene diglycol, ethylene or propylene triglycol, polyethylene or polypropylene glycol, 1,2-propandiol, 1,3-propandiol, 1,2-, 1,3-, 1,4-butandiol, 1,5-pentandiol, 1,6-, 1,5-hexandiol, 1,2,6-, 1,3,5-hexantriol, neopentylglycol trimethylolpropane, pentaerythritol, sorbitol acetate, sorbitol diacetate, sorbitol monoethoxylate, sorbitol dipropoxylate, sorbitol diethoxylate, sorbitol hexaethoxylate, aminosorbitol, trihydroxymethylaminomethane, glucose/PEG, the product of reaction of ethylene oxide with glucose, trimethylolpropane, monoethoxylate, mannitol monoacetate, mannitol monoethoxylate, butyl glucoside, glucose monoethoxylate, alpha-methyl glucoside, the sodium salt of carboxymethylsorbitol, polyglycerol monoethoxylate and mixtures thereof. An impact modifier maybe in the form of a plasticizer or in the form of an elastomer material. Impact modifying elastomeric materials include, but are not limited to EVA, EMA, TPE, metalecene and other similar forms of elastomers.

Natural or biobased plasticizers may be also used including soybean wax, natural waxes, glycerine, natural esters, citric esters, soybean oils, epoxified or heat embodied soybean oils and other similar plasticizers.

Other additives, such as congregated vegetable oils, glycerine (by-product of biodiesel production), soybean wax and other lower cost biomaterials, may be added as an additive in lower percentages to create a combination of lubricant action and bioplasticization of the biopolymer, while improving the lubrication within the profile die process. These forms of material lower the cost of the end product while maintaining the environmentally friendly bio-composition. These forms of material also may assist in improved dispersion of various fire retardants, fillers, and fibers while improving the impact strength of the overall system.

The addition of a low molecular weight bioplasticizers/lubricant system within the embodiments of the present invention allow for better loading of these forms of powders into the biopolymer matrix which provides better processing parameters and increases flexibility and impact resistance. Examples of plasticizers which may be used according to the invention are esters comprising: (i) an acid residue comprising one or more of: pthhalic acid, adipic acid, trimellitic acid, benzoic acid, azelaic acid, terephthalic acid, isophthalic acid, butyric acid, glutaric acid, citric acid or phosphoric acid; and (ii) an alcohol residue comprising one or more aliphatic, cycloaliphatic, or aromatic alcohols containing up to about 20 carbon atoms. Further, non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. The plasticizer also may comprise one or more benzoates, phthalates, phosphates, or isophthalates. In another example, the plasticizer comprises diethylene glycol dibenzoate, abbreviated herein as “DEGDB”. Examples of bioplasticizers include, but not limited to, hydrogenated vegetable oils, epoxified or congregated vegetable oils, drying oils derived from vegetable oils, mineral oils, natural waxes, polylactocaptone, citric acid and others. The resultant material of a PLA in combination with a plasticizer or bioplasticizer is considered to be a bio-co-polymer system. Lower loadings of a bioplasticizer may be used to maintain a rigid profile or sheet extrusion component and high loadings will further impart additional flexibility. Flexible or higher impact properties may be required by the varying product applications.

All forms of plasticizer additions to the biolaminate layer or assembly may assist in both impact resistance and in making the biolaminate layer more flexible in nature to match the performance of flexible PVC film products. Although various plasticizers may be used for a flexible biolaminate or for impact modification, it may be preferred to use a biobased plasticizer to maintain the biobased environmental position of the product.

Additives may be added into any layer or film of a biolaminate assembly provided herein. In some embodiments, the additive may be selected to maintain a degree of clarity—for example in a clear or semi-clear film coating layer over decorative veneers so as to allow the natural look of the veneer to be seen through the biolaminate layers. Additives may include but are not limited to, color additives, nucleating agents, petrochemical polymers, or other functional or aesthetic additives. The additive may be present in an amount less than about 50%, less than about 40% or less than about 30% of the total makeup of the biolaminate film, for example.

Petrochemical additives may be in the form of traditional plastics and/or plastic additives to impart changes in functionality and performance.

In some embodiments, fillers, including synthetic materials, natural minerals, and biomaterials, may be added to the biopolymer of the biolaminate layer. Such fillers include biofibers, proteins, starches, vegetable oils, natural fatty acids and other materials. Fibers and minerals typically help in the viscosity and processing of various plastics.

In some embodiments, the biolaminate layer may include further components adding other functionality to the layer. For example, the biolaminate layer may include quartz or other minerals and fibers.

Cellulosic Layers

In some embodiments, resin impregnated paper substrate or backer layer may be provided as part of or in contact with the one or more biolaminate layers of the biolaminate assembly. The layer may include forms of polylactic acid or other biopolymers to create a biobased and environmentally friendly alternative to formaldehyde based high pressure laminates. Embodiments of the invention may utilize either molten PLA or forms of processed lactic acid liquids that are impregnated into the one or more layers of paper. The saturated paper or paper layers may be heat formed into a decorative or functional laminate. The one or more layers may be contacted with heat and/or pressure sufficient to cure or polymerize the resin. In some embodiments, additional cellulosic layers impregnated with a bio-based polymer may be provided to form a thicker biolaminate structure.

In a first cellulosic embodiment, the biolaminate assembly may include a first cellulosic layer and a second cellulosic layer. A first bio-based polymer, such as polylactic acid or lactic acid, may be provided between the first cellulosic layer and the second cellulsoic layers. Fusing of the first cellulosic layer, the first bio-based polymer, and the second cellulosic layer may impregnate the cellulosic layers with the first bio-based polymer substantially throughout the cellulosic layers.

In a second cellulosic embodiment, the biolaminate assembly may include a first layer and a second layer in contact with the first layer. The first layer may be a paper substrate impregnated with a bio-based polymer such as polylactic acid or lactic acid. In various embodiments, the second layer may be a paper substrate impregnated with a bio-based polymer, may be a biobased film including a PLA sheet, or may be a clear PLA surface layer. The biolaminate assembly exhibits substantially no formaldehyde emission and may be suitable for replacement for high pressure laminates.

Embodiments of the present invention include biolaminate assemblies utilizing a saturated paper with substantially no formaldehyde emission. Various other layers may be provided with cellulosic embodiments. For example, decorative layers (including printed layers), overlay layers, wear layers, or other functional layers may be provided. An example decorative layer comprises a film layer, such as a PLA film layer, reverse printed with an image. The printed PLA film layer may then be provided within the biolaminate composite, such as over the first and second cellulosic layers. Overlay papers may be reasonably transparent when impregnated and cured. Either a clear polylactic or bioplastic or bioplastic/petrochemical plastic blend may be fused onto a biolaminate layer or a plain paper saturated with PLA or LA may be thermally fused onto the surface, also providing a good transparent layer, for example. Suitable overlay layers may include a thermoset and thermoplastic standard overlay, a mineral plastic overlay, a bioplastic overlay, or a wear layer surface overlay.

Accordingly, various forms of polylactic acids may be saturated into papers for the production of a biolaminate layer. Further, additives may be contacted with the polylactic acid as described above. Other bioresins and biobased polymers also may be used for paper saturating and produced into a single or multilayer laminate layer as an alternative to petrochemical formaldehyde based laminates. For example; biobased resins such as polyurethanes, polyesters, nylong and monomers such as polyols, organic acids and other similar biobased resins may be used to saturate papers for laminates. New generations of protein polymer chemistry also may be included such as Zein proteins, soybean protein and other bioresin or bioadhesive blends. Such biobased adhesives or polymers may be used in a liquid form either in their natural liquid state or by heat melting into various viscosity liquids in which the paper may be saturated and eventually cured in a single or multilayer biolaminate structure. Other new biopolymers derived from dextrose such as 3HP chemical platforms that lead to acrylic acid and acrylic polymers may also provide a biobased resin that may be used by itself or in combination with other biopolymers including PLA and the like.

Currently, paper from wood may be the primary source of paper used for a cellulosic biolaminate composite. However, any suitable woven or nonwoven cellulosic paper may be used. Suitable papers include, for example, plain paper, kraft paper, treated paper, wood based paper, recycled papers, decorative paper, printed paper, fiber reinforced papers, glass fiber reinforced paper, thin wood veneers, fire retardant paper, chemically treated paper, ph adjusted papers, or a combination thereof. The cellulosic paper may be a biobased paper from a renewable plant fiber such as hemp, baggase, wheat straw, and corn stover.

In one embodiment of a biolaminate including a cellulosic layer, four laminate layers are provided and fused and topped with a textured release paper. The bottom layer is a PLA layer, the second layer is a decorative paper, the third layer is a PLA layer, and the fourth layer is a wear layer. Heat and pressure may be used to fuse the layers, thereby saturating and impregnating the decorative print paper layer with PLA. If provided over a substrate such as a wood composite substrate before application of heat and pressure, the heat and pressure operate to fuse the layers into the wood composite substrate. The textured release paper is provided over the wear layer.

Surface Wear Layer/High Performance Layer

A biolaminate surface layer may be provided having wear or high performance layer characteristics. Such biolaminate surface wear layer may include natural fine quartz materials for specific high durability surfacing applications, while still maintaining a translucent material. Various natural minerals such as silica (natural quartz), alumina, calcium carbonate, and other minerals may be used in the production of flooring products to provide a higher degree of wear resistance and hardness. These wear resistant materials may be in the forms of medium particles that may be seen by the eye as decorative and functional particles. Such fine powder material becomes clear or semi-translucent in the bio-co-polymer matrix or in nanosized form within the biolaminate layer. The natural minerals may be included in a surface layer of a multilayer biolaminate layer or within a single biolaminate layer positioned near the surface of a biolaminate composite assembly.

The “nanoquartz” technology may provide good performance and durability of the surface. Natural quartz or silica sand in various particle sizes from nano-sized to larger sizes may be used in decorative applications and be added to the biolaminate system. Although, within embodiments of this invention, other natural minerals may be used, natural quartz is one of the hardest materials in nature. A biolaminate laminate assembly integrating quartz may also provide a lower cost option for expensive granite and other solid surfacing composites for kitchen countertops, tables, and other higher performance areas. These forms of biolaminate layers may be either flat laminated or thermoformed into three dimensional worksurface for kitchen and other forms of countertop applications.

In alternative embodiments, the surface wear layer may comprise a polyether ether ketone (PEEK) polymer. PEEK is a biomedical plastic widely accepted for medical and other applications. PEEK is FDA approved for food contact and is considered “ecofriendly.” A PEEK surface layer provides excellent properties in the areas of improved wear resistance, improved mechanical properties, high temperature performance, good electrical insulation properties, FDA compliant food contact, and improved fire resistant properties.

PEEK may be manufactured in either an amorphous grade or a semicrystalline grade. Amorphous grades; may be formed at lower temperatures and in these molding or thermofoiling operations will crystallize into a higher performance biolaminate surface. Thus, PEEK single layer biolaminate used as a top wear layer provides excellent performance and provides an ultimate “green” and rapidly renewable solution. Amorphous grades may be thermoformed into shapes and may be flexible in this form. By integrating a formable biolaminate with a PEEK wear surface layer, the ability is maintained to 3D-form over a non-plastic or fiber plastic composite to produce high performance countertops for kitchen, bath, store fixture, food preparation, and other hard usage applications.

Surface Wear Layer with Decorative Layer or as a Hybrid Laminate

In one embodiment, a two layer biolaminate composite may be provided including a clear quartz loaded surface layer thermally fused to an opaque biolaminate layer with printing encapsulated between the layers. In the case of a multilayer biolaminate layer, the layers of the biolaminate may be fused together by thermal processing with pressure or by means of a separate glue line or adhesive layer.

Another embodiment includes the utilization of a hybrid biolaminate. A hybrid biolaminate may refer to a biolaminate layer in which the biolaminate surface layer includes one or more layers in which the top layer may be another plastic than a biopolymer that is fused to the primary biopolymer base film. In this case, a biopolymer film including PLA or other forms of biopolymer, biocomposite or modified biopolymer are extruded into a primary base film. The bioplastic base film typically may be a white or background color suitable for printing. The base film may then be printed using direct inkjet printing or other methods of printing. A top wear layer clear film that may include polyester, acrylic, or other higher performance plastics may then be laminated onto the top, either using heat to melt the layers together or by means of a hot laminating clear adhesive. The final hybrid laminate may then have differing surface performances to meet a wider range of laminate applications. The hybrid laminate may then be laminated onto a wood or agrifiber composite substrate to be used as a cabinet, table, worksurface, kitchen countertop or other forms of components.

In the case of a single layer PEEK biolaminate, a white colorant may be added and the imaging may be done on the surface using dye sublimation to impregnate the image into the material, as opposed to just floating on top of the surface to provide improved wearing of the image. PEEK may be difficult to color and often comes in a natural “bronze” color. Dye sublimation may also work on this background color and through computer manipulation of images may adjust the images for a non-white background. Dye sublimation uses a dye rather than a pigment in which the dye molecules are smaller as to allow them to penetrate the molecular structure of the material. Thus, the image may not be scratched off the surfaces as opposed to common standard printing inks applied only to the surface.

Fibrous Layer

The biolaminate layer may include a biopolymer blended with natural fibers such as wheat, rice, and other similar forms of hydrophilic fibers. This, in addition to its organic nature, provides both higher degrees of wear resistance and improves char promotion in creating fire rated laminates and matching profile extrusion components. A fire retardant may be included in one or more biolaminate layers, in the adhesive layer, in the non-plastic rigid substrate or any combination with a biolaminate composite assembly.

A biolaminate layer including natural fibers or fillers may be desired due to their environmentally nature and for the fact that they provide a random geometry within the clear or semitransparent matrix yielding a natural look compared to an ordered “man-made” appearance commonly found in solid surface or repeating pattern high pressure laminate images. Natural fiber materials may include, but are not limited to: wheat straw, soybean straw, rice straw, corn stalks, hemp, baggase, soybean hulls, oat hulls, corn hulls, sunflower hulls, paper mill waste, nut shells, cellulosic fiber, paper mill sludge, and other agriculturally produced fibers. Wheat and rice fiber may be preferred for their shiny surfaces wherein these types of fiber are uniquely ground into long narrow strands and not into a fine filler powder as typically done in wood plastic composites. Although natural fibers may be preferred, other fibers, particles, minerals and fillers may be used, such as fiber glass wherein the bio-co-polymer may also impregnate the glass fibers within this process. Other forms of biobased materials may be used, such as seeds, proteins and starches, to expand the natural aesthetic nature of the biolaminate and matching extrusion profiles (such as edgebanding and other support components).

Fire Retardant Layer

In one embodiment, a fire retardant biolaminate composite assembly is provided and may include a biolaminate layer and an intumescent layer and may have good char and low flame spread with minimal smoke generation. The biolaminate layer may comprise a PLA sub-layer and may include a fire retardant. The intumescent layer may comprise an intumescent material that swells as a result of heat exposure.

The biolaminate layer may include fire retardants commonly used in dry fire extinguishers, such as ammonia phosphorus in combination with mica and silica. Such fire retardants provide good performance in a biolaminate composite assembly due to their pH and lack of reactivity with a bio-co-polymer system. These provide a high degree of flame suppression and induces char. Other fire retardants may be used, preferably non-halogenated retardants including alumina thyrate and magnesium hydroxides.

Additional materials may be added to the fire retardant bio-co-polymer (PLA/bioplasticizer) that reduces liquid mobility during burning, improving charring that insulates the material from heat during burning, and provides a higher degree of material integrity during burning as to hold its shape. Examples of additional char promoters include, but are not limited to: nanoclay, zinc borate, intumescent fire retardants, agricultural flour, wood flour, starch, paper mill waste, synthetic fibers (such as fiberglass or powders), minerals, and other materials. Other forms of drip suppressants, such as polytetrafluoroethylene, may also be used to reduce liquid mobility and be synergistic with the char promoters. Other forms of char promoters also may assist in stopping the liquid mobility or provide drip suppression, such as natural or synthetic rubbers. Such char promoters also provide additional flexibility or improved impact resistance for the biolaminate or matching profile biosolutions.

The resultant material has a very good char and low flame spread with very minimal smoke generation as compared to the high smoke producing PVC laminates that also are highly toxic. In regards to small amount of smoke generated, the smoke is semitransparent white or not seen at all.

In another embodiment, a fire retardant biolaminate composite door surface is provided and may include a biolamiante layer and an intumescent layer and may have good char and low flame spread with minimal smoke generation. The biolaminate layer may comprise a PLA sub layer and may include a fire retardant. The intumescent layer may comprise an intumescent material that swells as a result of heat exposure.

In yet another embodiment, a fire retardant biolaminate composite assembly is provided and may include a biolaminate layer and an adhesive layer wherein at least one of the biolaminate layer and the adhesive layer includes a fire retardant and wherein the biolaminate composite assembly has good char and low flame spread with minimal smoke generation. The biolaminate layer may comprise a PLA sub-layer. The biolaminate layer may be laminated to a substrate with the adhesive layer.

The fire retardant biolaminate composite may be provided in a wrap configuration such that the composite wrap may be wrapped over or under flooring, insulation, flooring, drywall, etc.

Intumescent agents are generally constituted by the polymer of the system and at least three main additives: an essentially phosphorus-containing additive whose purpose is of forming, during the combustion, an impermeable, semi-solid vitreous layer, constituted by polyphosphoric acid, and of activating the process of formation of intumescence; a second additive, containing nitrogen, which performs the functions of a foaming agent; and a third, carbon-containing additive, which acts as a carbon donor to allow an insulating cellular carbonaceous layer (“char”) to be formed between the polymer and the flame. In some embodiments, phosphates that release phosphoric acid at high temperature may also be employed.

Activated flame retardants may include an activated flame retardant comprising at least one nitrogenous phosphorus and/or sulfonate and at least one activator. An activator may include a char forming catalyst and/or a phase transfer catalyst. More specifically, activated flame retardants may include an activated nitrogenous phosphate flame retardant including the reaction product of: at least one nitrogen-containing reactant and at least one phosphorus-containing reactant capable of forming nitrogenous phosphate component, in the presence of at least one char forming tetraoxaspiro catalyst.

Examples of such compositions may be found in U.S. Pat. No. 6,733,697; U.S. patent application Ser. No. 2004/0036061 and U.S. patent application Ser. No. 2004/0012004, for example. Example flame retardants include CEASEFIRE™ products (Cote-1 Industries, 1542 Jefferson Street, Teaneck, N.J. 07666) and INTUMAX® products (Broadview Technologies, 7-33 Amsterdam St., Newark, N.J. 07105) for example

Decorative Layer

The surface layer of a biolaminate composite assembly may include a clear or semitransparent biolaminate layer in contact with a printed layer wherein various forms of printing methods and inks or dyes can be used to apply a decorative or customized feature on the printed layer. A suitable is a lactic acid based ink also derived from corn to provide a truly environmental biolaminate product.

The biolaminate composite assembly may be a decorative composite, including a clear biopolymer layer, an opaque biopolymer layer; and a decorative print layer. The print layer may be positioned between the clear layer and opaque layer. The clear layer may be textured. The layers may be optionally fused together.

The surface layer of a biolaminate composite assembly may include a clear or semitransparent film or layer that is direct printed on the top or outer surface and optionally liquid coated over the top to protect the printed surface and for improved surface characteristics. Liquid laminating may be accomplished by roll coating, rod coating (such as Mery rod coating), spray coating, UV cured coating systems and other standard coating systems.

The surface layer of the biolaminate composite assembly may include reverse direct printing wherein the print layer is positioned between the biolaminate and adhesive layer. This positioning allows the entire biolaminate clear layer to be a wear layer that can be refinished. In contrast, traditional high pressure laminate layers quickly wear through the pattern and can not be refurbished or refinished.

A decorative pattern may be printed on one or more sides of a biolaminate layer. The pattern may be on an outer surface or may be on an inner surface and visible to a user through a translucent biolaminate layer. Printing may include direct printing, reverse printing, digital printing, dye sublimation rotor gravure or other methods. Printing may occur at any suitable time, including before forming or laminating or after forming or laminating. Printing may be performed on one or more layers, pressed or laminated together, before the subsequent forming or laminating to a substrate. The printed layer may be in contact with the adhesive layer or may be on an outer surface. A protective, clear layer may be further contacted to an outer printed surface. Printing inks may include inks that provide sufficient adhesion to the biolaminate layer and can maintain adhesion in secondary heat laminating applications. Certain solvent based inks may not maintain sufficient adhesion during hot laminating processes. In addition the ink type needs to have some degree of flexibility as not to crack during hot thermofoiling processes and applications. UV inks are more environmentally friendly than solvent and are more preferred, but may not have sufficient flexibility or adhesion. New corn based inks derived from forms of lactic acid from corn are most preferred as to maintain the best environmental position and also provides improved adhesion while maintaining flexibility for such final applications and hot laminating processes.

The surface layer of the biolaminate layer may include two layers of biopolymer films wherein the top layer is a clear biolaminate film layer with a top surface texture and the second bottom layer is an opaque (i.e., white) biolaminate film layer with a print layer between the two biopolymer film layers in which the biopolymer film layers are thermally fused together or laminated by means of an adhesive. Once the multilayer decorative laminate is produced, it can be laminated in a manner similar to that of high pressure laminates onto various non-plastic rigid substrates including wood or agrifiber composite panels.

In one embodiment, a multiple layer biolaminate composite may be designed for unique aesthetic function. Multiple clear layers of the biolaminate may be printed with differing patterns and colors so that after multilayers of printed clear biolaminates are fused together, they provide a unique three dimensional depth of field in the image or pattern. Such an aesthetic depth of field is not found in HPL or PVC products, which are typically both opaque materials with printing on the surface. The multilayer printed biolaminate may utilize clear layering with an optional white back layer that provides for high quality and excellent image depth.

One embodiment of a multilayer biolaminate may include a biopolymer such as PLA, PHA and other clear, semitransparent or tinted film in which a secondary decorative solid printed film may be applied to a back or underside surface by means of a clear adhesive layer.

In many of the embodiments, a decorative layer may include a printed surface that is positioned between the one or more biolaminate layers or the biolaminate layer and a backer layer, surface layer or substrate, for example. In using PLA, many inks do not have sufficient adhesion to thermally fuse the layers together without potential delamination. Bioionks, such as BioVue and other lactic acid or biobased inks, are most compatible with the forms of biolaminate described above, especially in multilayer assemblies. In such embodiments, at least one layer may be in the form of a PLA film and the bioink may be efficiently and effectively utilized during any cold and post heat processes.

Other decorative layers may also be used in multilayer biolaminate assemblies, including decorative paper, decorative fiber sheet, random fibers, and organic materials. In the case of organic materials items such as straw, leafs, pine needles, and other natural materials, they may be positioned or “sandwiched” between the layers of a clear biolaminate to provide unique architectural translucent products for high end architectural applications.

Colorant System

The biolaminate layer or layers within the biolaminate composite assembly may include a colorant system. Colorants include, but are not limited to: pearls, particle granites, solids, dyes, “glow in the dark” additives, swirls, blends and other forms of decorative colorant systems. Colored minerals, fibers, and other forms of unique color and unique geometry particles may be integrated with the color into the biolaminate layer to provide solid surface aesthetics without requiring a printing layer.

Suitable inorganic colorants include metal-based coloring materials, such as ground metal oxide colorants of the type commonly used to color cement and grout. Such inorganic colorants include, but are not limited to: metal oxides such as red iron oxide (primarily Fe₂O₃), yellow iron oxide (Fe₂OHO), titanium dioxide (TiO₂), yellow iron oxide/titanium dioxide mixture, nickel oxide, manganese dioxide (MnO₂), and chromium (III) oxide (Cr₂O₃); mixed metal rutile or spinel pigments such as nickel antimony titanium rutile ({Ti,Ni,Sb}O₂), cobalt aluminate spinel (CoAl₂O₄), zinc iron chromite spinel, manganese antimony titanium rutile, iron titanium spinel, chrome antimony titanium ruffle, copper chromite spinel, chrome iron nickel spinel, and manganese ferrite spinel; lead chromate; cobalt phosphate (CO₃(PO₄)₂); cobalt lithium phosphate (CoLiPO₄); manganese ammonium pyrophosphate; cobalt magnesium borate; and sodium alumino sulfosilicate (Na₆Al₆Si₆O₂₄S₄). Suitable organic colorants include, but are not limited to: carbon black such as lampblack pigment dispersion; xanthene dyes; phthalocyanine dyes such as copper phthalocyanine and polychloro copper phthalocyanine; quinacridone pigments including chlorinated quinacridone pigments; dioxazine pigments; anthroquinone dyes; azo dyes such as azo naphthalenedisulfonic acid dyes; copper azo dyes; pyrrolopyrrol pigments; and isoindolinone pigments. Such dyes and pigments are commercially available from Mineral Pigments Corp. (Beltsville, Md.), Shephard Color Co. (Cincinnati, Ohio), Tamms Industries Co. (Itasca, Ill.), Huls America Inc. (Piscataway, N.J.), Ferro Corp. (Cleveland, Ohio), Engelhard Corp. (Iselin, N.J.), BASF Corp. (Parsippany, N.J.), Ciba-Geigy Corp. (Newport, Del.), and DuPont Chemicals (Wilmington, Del.).

The colorant system may be includes as a part of the biocomposite layer or may be included as a separate layer in a laminate.

The colorant may be added to the biocomposite layer in an amount suitable to provide the desired color. In some embodiments, the colorant is present in the particulate material in an amount no greater than about 15% by weight of the biocomposite matrix, in an amount no greater than about 10%, or in an amount no greater than about 5%. Preferably, colorants use biopolymer carriers to maintain the biobased characteristics of the biolaminates. Although standard color carriers, such as EVA, do not contain hazardous materials, it is preferred to use natural polymers as color carriers. A three dimensional appearance due to utilizing a clear biopolymer may be achieved within the embodiments of the present invention.

The surface layer of a biolaminate composite assembly may include a solid opaque colorant with optional fibers, fillers, or minerals to add decorative value to the product. The color and texture may be consistent throughout the product similar to that of a thin solid surface material.

In some embodiments, a latex paint layer may be incorporated into the biolaminate to provide a colorant system. The colored layer may be seen through the clear, semitransparent or tinted top layer 102. The clear or semitransparent textured film may be then backcoated using a latex paint thus also allowing for a quick ability to “color match” using standard paint chips from any brand of latex paint manufacturer. This allows a designer to stop in at a local store and select a very specific color. Embodiments allow for a quick production of an exact color matching biolaminate by simply. The colored layer may also function as an adhesive layer. The colored layer may adhere to an untreated PLA film as compared to other untreated petrochemical films. The colored layer (e.g. latex paint) may also include an ability to “stretch” thus allowing the biolaminate to be thermofoiled into complex contoured shapes without the paint layer cracking or releasing from the top biofilm layer. The latex may be matched to a specific designer's requirements for colóràhd/or various modifiers may be added to the paint for aesthetic or functional ‘needs. “The latex may direct coated on the back side by rolling, spraying, curtain coating or other common methods of painting. The surface may be typically coated entirely on the back side then dried using various methods known in the art.

The latex backside of the film may be laminated onto a non plastic rigid substrate using various laminating methods for 3D or flat laminating processes as described above. The latex paint also maybe highly modified with intumescent fire retardants, shielding metals, special effect additives, adhesion promoters, performance modifiers, UV initiators, “glow in the dark” components, magnetic particles, decorative chips or particles, and other additives compatible with the paint or colored layer.

Another embodiment may include taking the latex coated biofilm and laminating it first onto a saturated backer paper in which the backside latex coated film is laminated using cold or hot laminating adhesives and processes to create a two layer biolaminate. This then may allow a final user to laminate the biolaminate using standard methods onto various flat or contoured shapes similar to that of a prefinished wood veneer.

Another embodiment includes blending a clear or semitransparent tinted film with plastic pellets to create a film in order to create a high degree of transparent color. In this case the tinted film may be laminated directly onto a rigid substrate or a real wood veneer as an environmentally friendly coating and stain effect for the real wood veneer providing the end user with a biobased prefinished wood veneer. The clear or tinted biofilm may be laminated directly to the wood veneer using a clear or tinted laminating adhesive to show the real wood texture through the biofilm finish.

Glossed Laminate

Another embodiment includes two layers of biofilm laminated to create a biolaminate layer in which the top biopolymer film may be textured and glossed to a specific level for high pressure laminate applications. The base layer biofilm may be top printed and an pressure sensitive adhesive applied to the bottom or underside. The two biolaminate layers may then be fused together by means of heat or by means of a clear adhesive.

Clear or Transparent Film Layer

In some embodiments, a substantially clear, clear, or transparent film layer may be provided in the biolaminate composite. Suitable clear or semitransparent films include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like. Other forms of biobased polymers or plastics are also cellulose acetate and blends thereof.

Substrates

The biolaminate composite or any layer thereof may be laminated to a substrate. Such substrate may include non plastic substrates such as medium density fiberboard, particle board, agricultural fiber composites, plywood, gypsum wall board, wood or agrifiber plastic substrates and the like. One suitable substrate is a formaldehyde free wheatboard composite that is rapidly renewable. Further non plastic substrate may typically be a rigid wood or agrifiber composite commonly used for furniture, cabinet, millwork, laminate flooring, store fixture and other such applications. In most of these types of applications a fiat sheet may be used in which the biolaminate may be adhered to the surface and backside for balanced construction. In one embodiment, forms of profiles may be used in which MDF made from either wood or agrifiber can be machined into a three dimensional linear shape for millwork applications and the biolaminate layer may be formed and laminated onto this surface

A substrate may also be a wood or agrifiber mixed with plastic that is extruded into a final shape such as a millwork or window profile in which the biolaminate may then be formed and adhered to the surface by means of heat and a glue fine. The biolaminate layer in this embodiment may be either functional or decorative.

In addition glass panels can be laminated with the with a biolaminate as provided herein to create a semitransparent architectural panel product by using a clear laminating tape from 3M.

Biocomposite Substrate

In certain embodiments, a substrate may be provided for 3-D forming. Foamed plastic, plastic, or bioplastic composites may be useful due to the ability to utilize recycled plastics and provide a high degree of water resistance and final performance.

Various substrates can be formed and produced by using profile extrusion methods to create long continuous linear shapes. Primarily these can be based on foaming or composite fillers to lower cost and/or weight of the linear shaped while maintaining a high degree of performance. The integration of a plastic or bioplastic as the primary plastic or binder in the case of a biocomposite provides a higher degree of water resistance than traditional particleboard or MDF fiberboard substrates that provide a higher value and higher performance. In addition this also enables the substrate to have a higher degree of mold resistance that is a common problem for many woodbased composites substrates.

Foamed recycled Plastics—Foamed plastics or bioplastics can be produced using various foaming agents in an profile extrusion process. Various recycled plastics such as PVC, PET, PE, PP and other commonly used plastics can be recycled into foamed shaped components. Bioplastics and recycled bioplastics such as PLA, PHA and others can also be foamed into a final extruded shape. Although 100% plastic or bioplastic can be foamed, these forms of materials are waterproof, but may not have sufficient mechanical strength or heat distortion performance for many exterior applications. Applications such as a substrate for laminate flooring, millwork and other applications where mechanical strength is not required, these forms of foamed plastics maybe sufficient for a good substrate. Foamed plastics can typically use chemical blowing or foaming agents to create a light weight extrusion part. In Bioplastic either chemical blowing and foaming agents can also be used, but other forms of proteins or biofoaming agents can be used. In the case of bioplastics it is preferred to extrude these bioplastics such as PLA, PHA, below their melting point within their viscoelastic state. This maintains a higher degree of crystallization in the final material and allows for a higher melt strength to maintain a final 3D shape. Processing many biopolymer commonly above their melting point does not have sufficient melt strength to maintain a complex profile shape. Typically bioplastics such as PLA produced by Natureworks has a melt flow index of 4 or above. Typically plastics for good profile extrusion have a MFI of 1 or less that have a much higher viscosity and higher melt strength to hold its shape. Processing bioplastic such as PLA above it melt point has a viscosity similar to that of honey that has very poor ability to hold its shape, whereas an profile extrusion grade plastic with a MFI lower than 1 typically has a viscosity similar to that of “play dough” that can hold it shapes during extrusion.

Biocomposites and Composites—BioComposites are typically an plastic integrated with forms of cellulosic based materials that can be extruded or molded into various shapes. The addition of these forms of fibers or materials added to plastics increase the mechanical properties and mechanical or thermal stability of the plastic matrix while still maintaining a high degree of water and mold resistance. These forms of material can be processed into 3D components in the form of continuous linear shapes by extrusion methods or in 3D component substrate shapes by compression molding.

Wood/Plastic—Various forms of composite substrates can be produced using wood waste and plastic or waste plastics to form a composite matrix. Various wood sources that can be integrated are wood chips, wood fiber, wood flour, ground wood and other forms of wood waste products. Various plastics such as PVC, PP, PE, PET and others can be used as a binder and to increase the performance and water resistance.

Biofiber/Plastic—Various biobased fibers can be used in this invention to create a substrate such as wheatstraw, rice straw, corn fiber, soybean stocks, soybean hulls, oat hulls, corn hulls and many other forms of biofiber based materials. A synthetic plastic such as PE, PVC, PP, PET can be used, but it is preferred to use a bioplastic such as PLA or similar forms of bioplastics. Also higher loadings of biofiber materials in the composite matrix can use a lower viscosity binder or biobinder to allow improved flow during extrusion or molding processes. Biobased binders can include PLA, lactic acid, linseed oil, glycerin, and other forms of biobased binder systems. Optimally a biofiber in combination with a biobased binder system provide a truly renewable resource material. An area of development is in the usage of lactic acid with a biobased binder that provides a matrix resin that can be used with various biofibers including wheatstraw, rice straw, seed hulls, corn fiber, and other forms of agrifiber materials.

Bioplastic/Synth Fiber—Bioplastic can be extruded into a high tolerance shaped by means of viscoelastic processing methods wherein the processing temperature is below the melting point of the bioplastic. Although biobased fibers is the preferred addition to make a molded or profile extruded substrate, other synthetic fibers can be integrated to create even higher degrees of performance. Synthetic fibers such as fiberglass, carbon fibers, Kevlar, and other types of synthetic fibers can be integrated into these forms of substrates either in extrusion or compression molded processes. Examples of this system can be a PLA or Lactic acid matrix biopolymer with various synthetic fibers extruded into various shapes.

Plastic/Bioplastic and papermillsludge—Recycled paper or papermill sludge can also be a reinforcement with bioplastics such as PLA or Lactic acid/binder to create a environmental substrate. These can be in the form of high loaded solid extrusions or molded products or in the form of foamed extrusion.

Extruded or molded process—All of the above substrate composites or foamed plastics can be either extruded into 3D shaped by means of profile extrusion processes or can be processed into 3D shapes such as table tops or cabinet doors by means of compression molding into a specifically designed mold.

Other types of substrates may be extruded into final form or machined into a final form both being a 3D shape to be used in a wide range of building applications. For example, Extruded aluminum or synthetic fiber composites can also be extruded or pultruded to produce a higher performance substrate. Typically both aluminum or pultruded synthetic fibers are extruded using unique processes. Pultrusion is a process that orients a fiber linearly in the direction of the extrusion to maximize the mechanical strength of the extruded component.

Generally, the various substrates may be laminated with a biolaminate as provided herein to form a functional and/or decorative component in both substantially flat and 3D forms. Further, in 3D components, the components may be formed in linear forms of 3D molded component shapes.

Adhesives

Generally, any appropriate adhesive may be used and generally includes a substance that bonds two or more layers in a biolaminate layer or biolaminate composite assembly. Adhesives may include glues. Examples of adhesives include urethane, PVC, PVA, PUR, EVA and other forms of cold press or hot pressed laminating adhesives and methods. The biolaminate and laminates in general are typically adhered to a non plastics or wood/agrifiber composite material using various glues and laminating processes. Glues, such as contact cement, PVA, urethanes, hot melts and other forms of adhesives are commonly used in HPL (high pressure lamination). Although many of these glues may optionally work for embodiments of the invention, low or no VOC-containing glues are preferable in the adhesive system that may be either hot pressed, rolled or cold pressed processes to adhere the biolaminate layer to a substrate.

It can be difficult to adhere a plastic film to forms of foamed plastic or plastic composites using standard methods and adhesives. New forms of water based heat activated urethanes and forms of urethane hot melt adhesives now allow this ability.

Water based urethanes—New forms of water based urethane adhesives are both environmental and have very good bonding performance. Other forms of standard laminating adhesives may not work for plastics or plastic composites nor provide the appropriate level of adhesion. A water based urethane such as one sold by Daulbert Corporation used for thermofoiling to real wood composites can be used wherein the water based adhesive is sprayed or rolled onto the substrates mentioned above. The water is flashed off by air drying or forced heat, but at a temperature low enough not to polyermize the adhesive. By using heat and pressure by means of a roller or compression system a thin biofoil or biolaminate can be adhered to the formed surface. The heat does two primary functions: softens the biofoil or biolaminate to allow it to be shaped into three dimensional shapes and activate or polymerize the urethane to provide a strong bond. In tests temperatures required for this range between 100 to 200 degrees F. and more preferably 150-180 degrees F. If the temperature is too hot, the biofoil or biolaminate surface can melt or loose its textured surface. If temperatures are too low, then the biofoil or biolaminate does not sufficiently form or stretch to form over the three dimensional shape. Also the urethane may not cure to its full potential. IN this case the biofoil or biolaminate ranges from 0.005 to 0.1″ in thickness and more preferably is in the thickness range from 0.010 to 0.030″. IN our testing we have found that these forms of biofoils or biolaminate have a low heat distortion temperature that allows a lower processing temperature and allows for “sharper” edges in forming than conventional petrochemical plastics. In addition by integrating the biofoil or biolaminate with a biobased composite or foamed substrate provides a 100% biobased solution that meets new environmental market demands and biopreference governmental programs.

Hot Melt Urethanes—Urethanes also come in a solvent free or 100% solids form that require heat to liquefy the urethane to flow and provide a good adhesive bond. These forms of hot melt urethanes are produced by companies such as 3M, HB Fuller and others for a myriad of applications. The hot melt urethane provides a strong bond to the bioplastic composite to the biofoil or biolaminate. The heat from the hot melt adhesive also provides an improved bond to the polar natured bioplastic used in the substrate and biobased biofoil or biolaminate.

Example Composite Assemblies

Mineral Wear Layer Embodiment

In one example of a biolaminate composite assembly, the top layer may be a biolaminate loaded with natural quartz to provide a high wear surface. The second layer may be a top printed white sheet of biolaminate. In this case, the quartz biolaminate layer may be fused together with the printed bottom layer by means of heat and pressure or by means of a clear adhesive.

Peek Wear Layer Embodiment

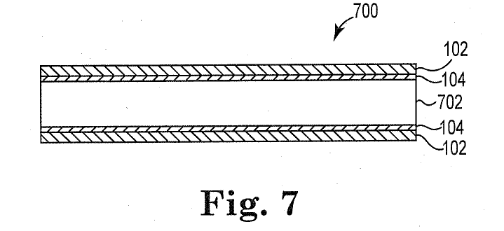

Referring to FIG. 7, a cross-sectional view of a biolaminate composite assembly utilizing a high performance surface layer is shown, according to some embodiments. A non-plastic rigid substrate 106 may be in contact with an optional adhesive layer 104. The adhesive layer 104 may be in contact with one or more biolaminate layers 102. The substrate 106 may also be in contact with the layers 102, for example. A biolaminate layer 102 may include multiple layers, such as thin films. A high performance layer 702 may be in contact with the one or more biolaminate layers. It is to be appreciated that while specific discussion may be made below to a PEEK high performance layer, an alternative high performance layer such as a quartz wear layer may alternatively be used.

Embodiments of the invention include the integration of a high performance surface layer 702 in contact with the one or more biolaminate layers 102, on a surface side of the layers 102. The high performance layer 702 may be a PEEK layer.

Between the biolaminate layer or layers 102 and the high performance layer 702, a decorative layer or ink may be positioned. If an ink, it may be printed on either the biolaminate 105 or high performance layer 702 to provide aesthetic value. PEEK is a very high performance thermoplastic with exceptionally high heat resistance. Heat resistances of various PEEK films or coatings are above 500° F. on a continuous basis. Other forms of current surface layers only have continuous heat resistances at slightly over the boiling point of water (212° F.).

The high performance surface layer 702 may be applied in various methods and forms.

In one embodiment, the layer 702 may be thermally fused onto the surface of the biolaminate 102. This may also be done using a clear adhesive layer between the biolaminate and PEEK surface.

The high performance layer 702 may also be used as a single layer laminate that may be thermofoiled into various shapes.

Although a single layer of PEEK may be used, another embodiment includes the use of PEEK as a surface wear layer in combination with the biolaminate 102.

Decorative Colored Embodiment

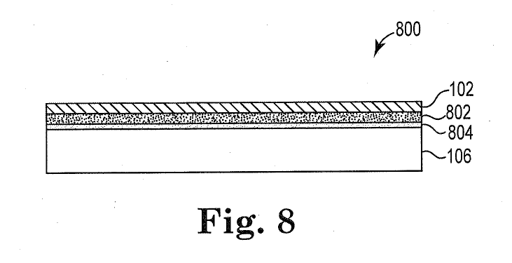

Referring to FIG. 8, a cross-sectional view 800 of a colored biolaminate composite assembly is shown, according to some embodiments. A rigid non-plastic substrate 106 may be in contact with a colored layer 802. The colored layer 802 may be in contact with one or more biolaminate layers 102. The substrate 106 may also be in contact with the layers 102, for example. A biolaminate layer 102 may include multiple layers, such as thin films. The substrate 106 may be further contacted with an additional rigid substrate, for example. The assembly may include optional adhesive layers. An optional backing layer 804 may be in contact with the substrate 106 and colored layer 802, for example.

The one or more biolaminate layers 102 may include a polymeric clear or semitransparent film made of the following polymers, but not limited to: PVC, PET, Celulose Acetate, PC, Acylic, Polystyrene, ABS, PEEK, Teflon films or combinations thereof. Polymer and biopolymer films such as PLA, PHA, cellulose acetate and other rapidly renewable or biobased plastics are preferred in order to provide a substantially or entirely “green” product.

The clear or semitransparent film (i.e. biolaminate layers 102) may be in a thickness of about 0.001″ to about 0.050″. The top surface of the film layer may be textured to a specific gloss and texture typically in the range of common laminate surfacing. Texture and gloss may be imparted during the extrusion process creating the clear of semitransparent film or may be post-pressed using hot platen presses or continuous hot rollers to impart 1 é correct texture and gloss.

The end performance related to mar, scratch, and wear may be affected by the type of texture imparted onto the clear or semitransparent film surface top surface layer (a top surface of the one or more biolaminate layers 102). The film may be in the form of sheets or rolls. Although embodiments of this invention include a range of petrochemical and biobased polymer films, the most preferred method uses a biobased film to provide an environmentally friendly product.

Embodiments of the inventions include the use of a colored layer, such as latex or oil-based paint, contacted to an underside of the biolaminate layers 102, top side of a substrate 106 or on an optional backer layer 804.

Decorative Fused Random Particle Embodiment

In some embodiments, various forms of aesthetic multicolored biolaminate assemblies may be formed of a biopolymer matrix resin and novel biocomposite random particles to create a wider range of aesthetics and a three dimensional appearance. The resultant sheet product has the natural appearance of natural granite and can be used in a myriad of building applications where a high aesthetic value and environmental properties are desired.

The invention creates a novel material and product that has a significant depth of field. The decorative biocomposite particle is non uniformly coated with a liquid colorant and wax (for example, hydrogenated vegetable oil). The biocomposite particles may comprise, for example, fully impregnated fibers with no colorant and/or fully impregnated fibers with colorant. In processing these provide different optical effects creating flow and visual layering. The bioplastic matrix resin is even more transparent or semitransparent. Thus the end material may have multiple levels of transparency creating a truly three dimensional or natural appearance.

The invention is designed to be produced in the forms of a surfacing material to replace formaldehyde based high pressure laminates and PVC thermofoils. In these cases both products are produce using a single dimensional by using a printed paper on its surface layer. These types of decorative overlays or laminates ate of a low cost and due to its optical nature does not have the three dimensional or depth of field of natural materials. In addition the printing process is restricted to repeating patterns over an area. In this invention the resultant material is truly a random fractal geometry wherein no one piece is an exact duplicate similar to that of natural stone.

PLA provides for both unique properties and unique clarity when blended with various microparticles can create a myriad of decorative and functional products. Biocomposite particles derived from PLA, paper mill sludge and various additives can be extruded wherein the paper mill sludge is colored in its natural state or by coating processes. PLA is biocompositable, but not truly biodegradable according to public sources and its manufacture. PLA has a surprisingly good stability when subjected to UV light or direct sunlight. Paper mill sludge also has good UV resistance due to the mineral filler used in the papermaking process. A biocomposite particle consisting of colored paper mill sludge and PLA can be extruded into various forms such as sheet, decking, siding, railing, fencing, architectural components, baseboard and other decorative and functional applications. Optional additive can be added with the biocomposite particles consisting of PLA/Paper mill sludge including plasticizers, impact modifiers, thermal stability agents and fire retardants. Although biocomposite particles can be produced with PLA and various cellulosic materials for extrusion, paper mill sludge has advantages in higher loading, improved performance and derived from a waste stream.

Decorative biocomposite particles may be produced in various colors, geometries, and sizes. The decorative biocomposite particles blended together to have various decorative performance characteristics. The decorative biocomposites may beused as a biocolorant system for various bioplastics and biocopolymer systems. By fusing various sizes, colors and geometries of the biocomposite particles with a matrix bioplastic or biocopolymer then formed into a sheet or three dimensional forms, a three dimensional appearing solid surface with a pattern is provided having an appearance similar to granite while providing true performance of solid surfacing materials.

Ground fluffy cellulose similar to that of cellulosic insulation may be used to as a basis for the decorative biocomposite particles, although other decorative fiber systems can be used with similar fibrous nature providing a hydrophilic nature for impregnation and maintain their integrity as not to form a homogenous looking composites. As most composites strive for homogeneity, this invention is based on a random particle geometry to provide aesthetics to the final decorative biocomposite and biolaminate product.

Additional materials comprise of random particle paper mill sludge, agricultural fiber that has been fiberized or in random geometries, and fiberglass. In these materials it is important that the material be hydrophilic to allow impregnation of the hydrogenated soybean oil or natural waxes with colorants to form a higher integrity particle for optimal aesthetic performance.

Although the invention is based on a hydrophilic biocomposite decorative particle, other particles can be blended with the decorative system. Regrind PLA particles can be colorized by simply painting the outsides of the individual particles on a single side. As these particles are deformed using heat and pressure, the resultant material has another unique aesthetic effect. As the material is processed, the clear biopolymer particles may be seen through such that the back painted side of the particles is visible. These forms of bioplastic particle can be blended with a biocomposite particle to provide even greater aesthetic effects and values. Colored and coated decorative biocomposite particles are compounded through extrusion methods with a typically clear or semitransparent bioplastic or biocopolymer. In some cases the bioplastic or biocopolymer can be precompounded with a separate color than the biocomposite particles.

The coating of the PLA also provides other unique characteristics of the final biocomposite material. The coated biocomposite particle generally has a natural fiber color inside and a colored coating or liquid colorant and wax of a different material on the outside. This bi-material coated bioparticle has unique thermal property and provides unique aesthetic potentials. Coatings are used primarily for color and to better maintain boundary conditions during thermal fusion processing. These coatings can also include fire retardants, fibers, minerals, fillers, metal, and other additives for aesthetic or performance requirements of the final fused particle biocomposite sheet or shaped product.

The optical properties using the coated biocomposite particles also are unique. As an example, the biocomposite particles may be compared to application of a metallic paint to a clear glass plate—the top side will represent the color of the paint but not be perfectly smooth on an optical level whereas the bottom side, where the interface of the paint and the glass is viewed, will have a different optical property. Also by seeing through the clear plate glass to this interface, a depth of field is perceived. As applied to the coated biocomposite particles, the interface of the paint and the particle is viewed, not the direct surface of any paint.

The invention can start with either dyed, clear, or semi transparent colors of polylactic acid preferably in the form of regrind that provides for a clear inside of the biocomposite particle. In addition the PLA can be compounded to contain various multicolored microparticles to create a semitransparent or light diffused medium to create individual particles. By blending various color, light diffusion characteristics, geometries, sizes, and other various optical property biocomposite particles together, once fused they have unique optical properties and translucence that provides a true depth of field in this biobased solid surface material. As in the value of natural granites in the market the higher the “depth” of the material or ability to see into the granite, the higher its value. Solid surfacing material typically does not have this type of depth of field or in using clear resins look unnatural as particles uniformly floating in a clear resin.

Within the biocomposite particle matrix the coated particles may have clear or semitransparent insides. To create a semitransparent inside various cellulosic or mineral microparticles are used wherein the depth of field is changed, but still has a depth of field.

Dye saturating paper mill sludge can be produced by adding paper mill sludge to water based dyes commonly used in clothing and still maintain its shape.

Natural colored biocomposite particles can also be produced by using natural colors found in the environment including various forms of agricultural materials, industrial byproducts, wood byproducts, natural wood shavings, minerals, and other three dimensional shaped and colored materials. In this case these forms of decorative additives are in the form of microparticles approximately less than 50% the size of the primary biocomposite particle, more preferably the microparticles are less than 0.060″ in diameter and of a three dimensional random geometric shape to provide for good optical aesthetic appeal. By using natural colored microparticles it is not necessary to use chemical based colorant for applications where the environmental position is highly desired.

Various functions of the biocomposite biocolorant systems have a significant effect on aesthetic values for producing biolaminates and supporting components. Although ground recycled cellulose is one suitable material to start making the decorative coated biocomposite particle, other forms of cellulosic materials can be used to provide a unique geometry and aesthetic effect. Paper mill sludge, agricultural fiber and other natural fibers can be process and coated with a liquid colorant and hydrogenated vegetable oil or wax and processed by similar means. This method creates a wider range of biocomposite particle geometries that allow different aesthetic values and patterning.

The resultant material comprised of the decorative color/wax coated biocomposite particle in a semitransparent bioplastic or biocopolymer matrix provides for a wide range of applications. The primary application within this invention is to produce this biocomposite material into thin sheets similar in thickness to that of high pressure laminates and PVC thermofoils. Typical thicknesses range from 0.012″ to over 0.125″ and more commonly from 0.020″ to 0.040″ The decorative biolaminate can be textured on the surface while the material is being extruded into sheet form by means of textured rollers. The backside of the highly decorative biolaminate can be treated by means of corona treatment, flame treatment or other means to promote adhesion of the biolaminate to the nonplastic substrate.

In various architectural applications where biocomposites are preferred over petrochemical or hazardous plastics, there is a need for making the biocomposite particle more elastomeric in nature. Plasticizers can be added to make or with the biocomposite particles that maintain the semitransparent nature of the biocomposite materials. Plasticizers such as glycerol, oleic acid, and other fatty acid or natural oils all provide the ability to make the biocomposite particle of PLA and microparticles more elastomeric. In providing a green solution for many applications the usage of naturally derived plasticizers from vegetable processing is preferred, but not limited to.

The decorative biocomposite particles or biocolorant system can be added to bioplastics in other extrusion or plastic processing applications. Profile extrusion of PLA can be done by novel processing methods and additive as disclosed in the inventors' previous patent applications. The resultant stone looking profile is 100% biobased and can be used for cornerguards, baseboard, edgebanding, office dividers, millwork, and other architectural components wherein they wish to replace PVC or other petrochemical extrusion products with an environmentally friendly and highly aesthetic product. Other processes to produce components can be injection molding, blow molding, and other forms of plastic processing.

In some applications additional performance maybe required such as schools, hospitals and other institutional or commercial buildings where a class I fire retardant is required. A fire retardant package comprising of forms of ammonium phosphate can be added to either the PLA or to the biocomposite particle which is gently mixed in the extrusion process to create fire resistant biolaminates or matching profiles.

Veneer Embodiment

Referring to FIG. 7, a cross-sectional view 700 of a veneer biolaminate composite assembly is shown, according to some embodiments. A veneer substrate 702 may be in contact with an adhesive layer 104. The adhesive layer 104 may be in contact with one or more biolaminate layers 102. The veneer substrate 702 may also be in contact with the layers 102, for example. A biolaminate layer 102 may include multiple layers, such as thin films. The veneer substrate 702 may be further contacted with a rigid substrate, for example.

The veneer 702 may include a decorative pattern, texture or appearance. The biolaminate layer 102 may be a clear, semitransparent or tinted film, for example. An optional saturated backer paper layer may be positioned on the underside of the substrate 702, in place of the lower biolaminate layer 102 and adhesive layer 104.

The assembly may include the veneer substrate 702, a clear, tinted or semitransparent biopolymer film 102 with an optional textured top surface, a saturated backer paper and clear laminating adhesives 104.

Wood veneers are commonly produced using various veneering processes. Some new processes are being developed to further create reconstituted veneers or wood veneers of very thin and fragile nature as to optimize the output from a tree. These veneers are difficult to finish and process by conventional means. Wood veneers may be either real wood or reconstituted wood veneers.

A backer paper, such as Neehan latex saturated backer paper, may be used as a composite backer. The backer layer may be on the underside or lower layer of the veneer substrate 702, replacing or in addition to the lower adhesive layer 104 and biolaminate layer 102. Alternatively to the backer layer, rubber, fiber rubber composite sheets, rigid substrates, or other composites may be contacted with the veneer substrate on a underside or lower side of the veneer.

The final biobased veneer assembly including a textured biofilm top layer, wood veneer layer and backer may be used either for flat laminating onto a rigid substrate or three-dimensional (3D) formed and laminated onto a contoured 3D rigid substrate. Substrates may include, but are not limited to, wood composites, agrifiber composites, plastic fiber composites, cement fiber composites and a other forms of composite substrates.

The biobased veneer may be laminated on various 3D rigid substrates such as raised panel components for passageway doors and cabinet doors. In this case the veneer may be sanded and spray finished as part of a larger wood assembly that requires a final finishing process. The veneer assembly has a good adhesion function with various common types of wood finishes as compared to most petrochemical plastics.

The veneer assembly may be laminated to form a wide range of applications including, but not limited to, cabinets, cabinet doors, passageway doors, store fixtures, furniture, millwork. Flooring, wall covering, railings, ceiling tiles, and other veneer applications.

Corrugated Embodiment

Embodiments of the invention also relate to a structural and/or decorative light weight panel or laminate assembly including one or more face layers or sheets in contact with an extruded bioplastic substrate or core body. An adhesive layer may contact the substrate and layers, for example. The substrate or core body may be highly resistant to moisture attack and optional open spaces between truss elements provide flexibility to accommodate thermal expansion and contraction. The structural assembly may have a higher stiffness as compared to polyolefins and a functional polar surface in which standard hot melt adhesives may be utilized.

In one embodiment, two or more metal face sheets may be used and the core body may be a corrugated bioplastic core body. The core sheet or body may be formed by a continuous plastic extrusion technique. Diagonal plastic webs or perpendicular plastic I-beams may be used for the truss elements of the biocorrugated material. A further embodiment includes one or more laminated layers of bioplastic corrugated sheets that may be glued together. Alternatively, only one face sheet may be used bonded to one side of the plastic core body, allowing it to be used as a veneer or curved around rounded structures. Further embodiments include surface sheets such as high pressure laminates, rigid plastic, natural fiber reinforced sheets and fiberglass sheets, for example.

The biocorrugated system may be used commercially or residentially to replace such moisture sensitive building materials as wood, plywood and composites made from either, for example. Embodiments of the present invention provide a lightweight, economical, environmentally friendly structural and/or decorative panel that may be resistant to swelling from moisture, weathering, freezing and thawing cycles. The panel is easy to fabricate and makes optimum use of materials during manufacture.

Embodiments include a structural panel having at least one face sheet made of a durable material with a high tensile strength and a core made up of one or more layers of corrugated bibplastit. The core layers may be laminated to provide an inner bioplastic truss element or elements spaced apart. The core may be contacted with the face sheet or sheets with an adhesive.

Adhesive bonding of the layers making up the core provides a high strength laminate bonding that is very resistant to delamination. The core may be bipolar and have a strong affinity for gluing, lamination and fusing by standard hot melt adhesive methods. The substrate may not require any surface treatment for adhesion, such as flame treating, corona or plasma treatments that may be hazardous and expensive. The bioplastic core body may be highly resistant to moisture attack and the open spaces between truss elements may provide flexibility to accommodate thermal expansion and contraction. The core may also have a high degree of stiffness, typically over 400,000 psi modulus of elasticity. The core or substrate may have an equal or higher stiffness as compared to many currently used interior core materials, such as particleboard: Additionally, the core may be lighter in weight than competing products and will not release any toxic formaldehyde glue vapors.

The use of a core body made of one or more bioplastics, such as PLA, PHA or PHHA, provides for unique properties of the overall assembly or system. Face sheets may be made of metal due to the high tensile strength of metal. Plastic, high-pressure laminates and fiber-reinforced skins may also be used for certain applications.

PLA or PHA bioplastic may be extruded in a profile or waved corrugated shape using processing methods to provide the desired shape or profile. The core may include a layer or multiple layers of bioplastic corrugated material, laminated in the same direction or crossbanded. Two metal face sheets may be bonded on opposite sides of a bioplastic core.

The overall assembly or system may be manufactured from thicknesses from 0.125 inches to over 1 inch, even when using two face sheets. Additives may be utilized with the bioplastics in the core to provide optimal or customizable properties. The layers of the bioplastic core may be laminated using standard hot melt adhesives and standard laminating processes. The core may be laminated with all flutes aligned for maximum linear mechanical strength in the same direction as the flutes, for example. Alternatively or subsequently, the corrugated bioplastic sheets may be turned so that every other one is in a different direction similar to that of plywood crossbanding to provide additional strength.

Lamination may utilize adhesives, such as EVA (ethylene vinyl acetate). Other adhesive material s may be reactive polyester epoxy or polyurethane or a variety of latexes, for example. Heat and/or pressure may be applied to the adhesive for spraying or misting. Since epoxy tends to be brittle, a polyurethane adhesive or a modified epoxy (TS) with greater elasticity may be used if the laminate is to be bent or worked. The bioplastic core derived from PLA or PHA provides a unique polar or functional surface that does not require any pretreatment for surface adhesive, as in polyethylene and most petrochemically derived plastics.

Truss elements may include I-beams, “x-brace”, wave or sinusoidal shapes. By creating open spaces in the truss system, the panel system is less expensive, lighter in weight and stronger than competing products that may use discrete structural elements.

Structural panels are often required to have thermal resistance when utilized as part of an outdoor wall construction. By using different and non-conductive materials for the core body (i.e., plastics), the panel of the embodiments of the invention offers high resistance to the flow of heat through the panel. The thermal properties of the panels leads to improved moisture control in building panel walls, because there is a lower tendency for condensation to occur and cause damage to the panels. The panels gf.tlie embodiments of the present invention may be superior to traditional plywood or wood paneling for a number of reasons. Conventional structural panels having plywood cores absorb water readily, have a lower quality of material and are increasingly becoming more expensive every year due to dwindling natural resources of old growth trees. Plywood suffers from natural defects such as knots, splits and biological deterioration. Water buildup or exposure causes corrosion, rotting and eventual consumption by natural degradation.

Applications for the panel and system described above may include metal cabinets and storage systems, pallets, restroom dividers, architectural panels, building panels, lightweight transportation panels, displays and exhibition panels, curved panels, seating, among others.

Three Dimensional Biocomposite Substrate Embodiments

In some embodiments, a three dimensional biocomposite substrate may be laminated with a biolaminate as described herein. Such 3D biocomposite may be useful in decorative millwork, window components, door components, or other linear components for building.

For example, the 3D biocomposite substrate may be a linear extruded biocomposite assembly comprising of a decorative biofoil and biocomposite extruded substrate used as a linear building component. The biofoil may beomprise a biopolymer, a biocopolymer, a modified biopolymer, or a biocomposite substrate. The biofoil may be decorative by means of printing, internal colorant, or decorative inclusion. The biofoil may be applied by linear wrapping process.

In another embodiment, the 3D biocomposite may be a linear wrapped biocomposite comprising an extruded substrate. The substrate may be a petrochemical plastic with agrifiber, a petrochemical plastic with wood, a petrochemical plastic with paper mill sludge, bioplastic such as PLA, or bioplastic in a biocomposite with wood, agrifiber and papermill sludge. The substrate may be foamed, solid, and/or comprise a foamed plastic or bioplastic.

### Wallpaper Embodiment

In some embodiments, a biocomposite substrate optionally with a biolaminate may be provided as a replacement for flexible vinyl wallpaper. Vinyl wall paper is highly used in commercial applications due to its cleanability and toughness. Flexible PVC contains significant amounts of plialate plasticizers which are considered very hazardous and emits dangerous volitiles. This invention uses PLA in conjunction with the Halstar plasticizer to create a similar flexible biofilm as used in the signage application only with the addition of a nonwoven or woven backer that is laminated onto the backside of the flexible PLA film during the extrusion process. As the flexible PLA is being extruded a cloth fiber backer sheet is compressed and fused to the backside of the viscoelastic flexible PLA film.

After cooled and rolled, the flexible backed film is then printed using a bioink derived from lactic acid. Optionally a clear liquid protective coating can be applied. Preferably the clear liquid is a form of the lactic acid ink. It also can be other standard coatings, but a clear bioink is preferred to maintain the 100% biopreferred product. Another option for the clear coating is another clear flexible PLA thin layer that is thermally fused onto the surface.

By the addition of the plasticizer with an optional lubricant we found that it is much easier to add powdered environmentally friendly non halogen fire retardants such as magnesium hydroxide and alumina tryhydrates. Thus by sufficient addition of a fire retardant, a high degree of flexibility is maintained while providing a product that can meet a Class I E84 fire rating for indoor applications code requirements.

Other additional value added steps can be included such as the application of an wall paper adhesive on the backside for assisting and easier application.

In one embodiment, such flexible wallpaper comprises PLA and a HalStar plasticizer and a biobased ink with biobased clear ink coating. In another embodiment, a decorative biowallpaper is provided that uses biobased inks derived from lactic acid and other biobinder/additives. In yet another embodiment, a biobased clear coat derived from clear lactic acid printing ink with an optional fire retardant may be provided. In a further embodiment, a biobased flexible wall paper derived from plasticized lactic acid with a woven or nonwoven backer is provided.

Methods of Making the Biolaminate Composite

Referring to FIG. 2, a block flow diagram 200 of a method of making a biolaminate composite structure is shown, according to some embodiments. A non-plastic rigid substrate 106 may be formed or laminated 202 with one or more biolaminate layers 102. Forming 202 may include thermoforming, vacuum forming, thermoforming or a combination thereof. Additives may be introduced before, during or after forming 202.

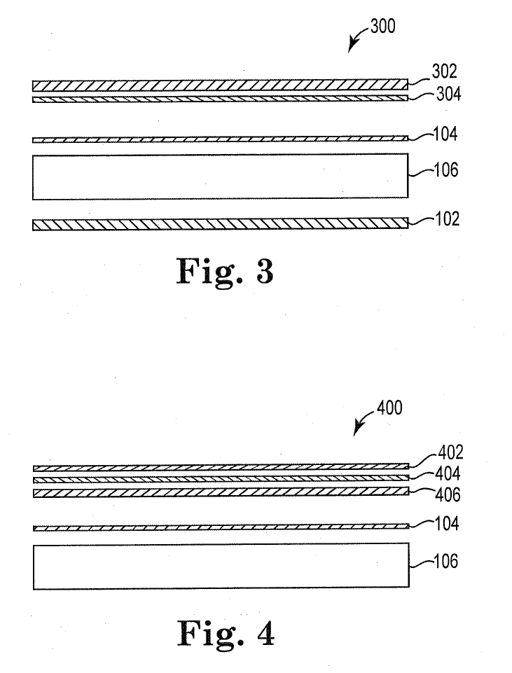

Referring to FIGS. 3-6, an expanded view (300, 400, 500, 600) of a biolaminate composite assembly is shown, according to some embodiments. A substrate 106, such as a rigid non-plastic substrate, may be contacted with a clear biolaminate layer 302 utilizing an adhesive layer 104 on a first side. The clear biolaminate layer 302 may be in contact with a reverse print layer 304, for example. In some embodiments, they may be joined by fusing for example. On a second side of the substrate 106, a second biolaminate layer 102 may be contacted, such as by thermoforming or lamination (see FIG. 3).

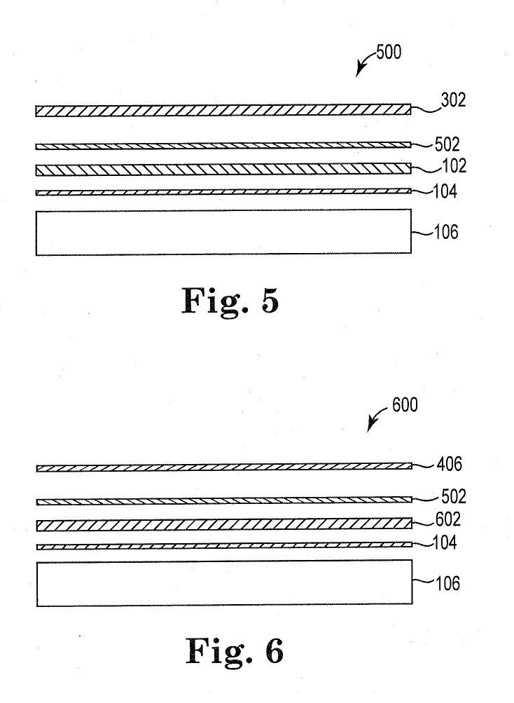

A clear biolaminate layer 406 may be contacted with a direct print layer 404 and then protected on an outer surface by a clear protective coating 402, for example (see FIG. 4). A biolaminate layer may include two or more layers, such as a white biolaminate layer 102, a surface biolaminate layer 302 and a print layer 502 in between (see FIG. 5). The surface layer 302 may be loaded with quartz, for example. In another embodiment, a fire retardant may be integrated in a biolaminate layer 602, then direct printed 502 with a decorative layer. A clear biolaminate layer 406 may face an outer surface (see FIG. 6).

Various of these steps will be described in more detail below.

Polylactic Acid or PLA is currently processed into packaging films in which an extrusion process is used to produce very thin sheet or films typically ranging from a thickness of 0.003″ to 0.060″. PLA is difficult to extrude due to its poor extensional viscosity or lack of ability to hold its shape in its molten condition.

When extrusion processing, most plastics such s polyethylene, polypropylene and other forms of thermoplastics utilize a melt index as a common method of the measurement of viscosity. Typically MFI of extrusion grades of these plastics are between 0.1 and 2 MFI This measurement is typically done at 190° F. wherein plastic is heated to this level and the amount of flow or material that passes through an orifice at a specific time. Extrusion grades have very high viscosity at these processing temperature levels where it can hold it shape for profile extrusion. Materials with higher melt flow index or lower viscosities have problems in profile extrusion and can not hold its shape. This is also from having a lower molecular weight than extrusion grade plastics. PLA has a melt index of between 4-10 and typically can not be below a 3 MFI. In addition PLA has a very unique thermal property in which there is a wider range between its Tg or heat deflection temperature and its melting temperature. PLA typically has a melt point close to its recommended processing temperature of 390 to 420 degrees F. PLA also has a heat deflection temperature that is lower than most common plastics at a little over 110 degree F. In normal plastic processing the temperatures to process the plastic are typically 10-20 degrees above the Tm or melting point of the plastic. In published data in regards to processing PLA, it is typically processed at temperatures above 390 degree F. which is the melting point of PLA.

PLA used in the biolaminate layer as provided herein may be processed above its melting point in extrusion film processing. The PLA used in the biolaminate may also be processed below its melting point in its viscoelastic state and maintain a higher degree of crystallinity in the biolaminate layer. For example, see U.S. patent application Ser. No. 11/934/508, filed Nov. 2, 2007, the disclosure of which is herein incorporated in its entirety. According to the embodiments of the invention, the extrusion process for producing the biolaminate layer may be performed at a temperature significantly lower than the melting point and keeps the PLA in its crystalline state and processes the PLA in its viscoelastic state. In one example, both a flat sheet can be produced, or a matching three dimensional profile such as a matching edgebanding or millwork piece.

U.S. patent application Ser. No. 11/934/508 teaches that PLA in combination with an EVA type or synthetic form of binder allows PLA to be processed below its melting point. In addition, this teaches that fire retardants may be added. In embodiments disclosed herein, the combination of the binder and highly polar PLA makes it difficult to load fire retardant to the required level to reach a class I rating without the material becoming extremely brittle and not meeting the requirements of PVC applications. Although this technique works well for producing a high tolerance profile shape, the addition of EVA is not necessary in these embodiments. Other forms of additives, along with processing at temperatures below the melting point of PLA, may achieve a similar result. Accordingly, embodiments of the invention use various forms of a bioplasticizer/biolubrication system to replace the binder in the above mentioned reference. In addition, the embodiments also show that by increasing shear rate and maintaining a lower processing temperature than the melting point of PLA, a high tolerance profile extrusion can be produced.

When processing the PLA at a specific temperature range, in which the PLA is in an “elastic state” similar to a rubber, the PLA stays in its amorphous state and acts similar to that of various other elastomeric materials. Also in this state, the material is less susceptible to moisture and shear. In fact, in processing it was found that higher shear levels when the PLA is in this elastomeric state provides advantages in profile extrusion and with the addition of various additives. PLA has a melting point of approximately 390° F. The embodiments of this invention teach that with sufficient shear, PLA may be processed at a temperature far lower than its melting point. In this embodiment, the profile extrusion process ranges from about 280 to about 340° F., and more preferably between about 300 to about 320° F. With the addition of high loadings of fillers, higher temperatures may be used, but preferably below the melting point of the PLA.

Biolubricants assist in this low temperature viscoelastic process, such as natural waxes, lignants or plasticizers. Preferably, the wax or plasticizers are based on biobased materials. Embodiments of the present invention describe a two component composition processed below its melting point into a profile extrusion continuous shape using a PLA and a plasticizer or biolubricant may create complex shaped profiles of high tolerance.

At these processing conditions, it may be possible to blend in various additives, fillers, and reinforcement materials in liquid or solid forms in addition adding various other polymeric additives to develop a wider range of end performance qualities for various non-biodegradable profile extrusion applications. The PLA also may be foamed using celuka die systems and a foaming or biofoaming agent to produce light weight profile extrusions. Other fillers maybe added to the solid or foamed profile shape, including wood fiber, wood flour, paper millsludge, agrifibers, cereal straws, minerals, fiberglass fibers, starch, proteins, and other forms of fillers or reinforcement. The resultant bioprofile may be colored throughout to match the biolaminate composite assemblies or printed using the same patterns as other biolaminates. This provides the ability to create a full solution for buildings, offices and commercial building as to allow for aesthetic matching of environmental components in architectural design.

The addition of fillers, either synthetic, natural minerals or biomaterials, may be added to the biopolymer in the elastomeric state. The addition of these materials in the biopolymer elastomeric state allows for processing using much higher shear rates, provides improved dispersion and provides less brittleness in the biopolymer by staying below its melting point and minimizing crystallization of the biopolymer.

As noted, the biolaminate layer or layers within the biolaminate composite assembly may include a colorant system. Colorants may be added directly into the biolaminate layer by mixing colorants with the biocopolymer and/or by coloring the fibers by means of dying or other coloring processes to provide single and multicolored high aesthetic biolaminates and matching profiles.

A biolaminate layer using primarily PLA with optional additives may be sheet extruded to meet the requirements of PVC or HPL decorative surfacing products. The extruded sheet of biolaminate may be processed either above the melting point to achieve a clear amorphous biolaminate or below the melting point in its viscoelastic state to increase its crystallinity. The extruded biolaminate may be extruded in thicknesses ranging from .002″ to 0.3″ and more preferably between .005″ to .030″ and most preferred between .010″ to .025″. The hot extruded biolaminate clear sheet may then be processed through various rollers for both cooling purposes and to imprint a texture on the surface and backside of the biolaminate. The top surface texture may range from a smooth high gloss to a highly textured flat surface. For worksurface, tables, and most cabinet door applications a gloss level between 10-30 degrees gloss may be preferred as not to show scratching and reduce light reflection. The backside of the biolaminate can also match the topside texture, but it is preferred to have a low flat gloss as to promote adhesion in laminating. Even though the biolaminate material may be clear, the addition of the same or different textures on both sides may make the biolaminate semitransparent and hard to see through.

After the clear biolaminate has been extruded, it may be optionally used in this form as a clear film finishing over raw wood or agrifiber composites as a direct replacement for liquid finishing providing a VOC environmental and high performance finish for such products.

In some embodiments, the semitransparent biolaminate may be direct printed on the topside, reverse printed on the backside or printed within layers of the biolaminate using various printing methods or inks (as discussed earlier). Methods of printing include, but are not limited to inkjet, rotor gravure, flexographic, dye sublimation process, direct UV inject printing, screen printing using standard or UV inks, and other means of printing. A bioink may be utilized in the printing process. One method for printing may be to heat either the ink or the substrate prior and after printing to maximize adhesion of the printing inks. In some cases, a primer layer may be utilized between the biolaminate surface and the printing layer to improve adhesion of these layers.

A printing process may be used to print a single layer clear biolaminate in which the print is reversed printed on the back side which may be a flat texture. The printing process wets out the flat surface and increases the clarity of the biolaminate. Heat laminating the biolaminate increases its amorphous nature. This may cause the biolaminate to become more clear, resulting in a higher quality of print. Because the printing is on the back side of the clear biolaminate, the biolaminate provides a thicker wear layer than PVC products that are typically printed on the surface with minimal or no protective layers to protect the aesthetic print layer.

Various printing inks can be used including solvent, UV cured, silkscreen ink and other forms of ink as long as there is appropriate adhesion and the ability to have some stretch for thermofoiling applications. In some test cases, certain inks are too rigid and may crack or loose adhesion in laminating processes. One suitable ink is a biobased ink (i.e, bioink) such as the type produced by Mubio for Mutoh Valuejet digital printing systems to provide a 100% biobased product including the ink layers.

Printing on a biofoil can be accomplished using any of the above described processes using direct, reverse or sandwich printing methods for the Biofoils to provide an high design look for the end product. The integration of digital printing also allows for mass customization of the products. In many cases the printing may be direct imaged onto a white biofoil with a clear protective liquid coating.

In one embodiment, a thin PLA film less than about 0.010″, less than about 0.005″, may be reverse direct printed using wide format digital printers or other means of printing. A recycled mineral fiber composite including fiberized mineral and a biobased binder with a heavy surface texture may be prepared by cutting to size and a heat activated adhesive may be applied to the top and side surfaces. The image on the PLA film may be of a pattern, photo, signage or typically any form of computer generated artwork. The composite may be placed in a thermofoiling machine along with the printed film over the surface. The PLA film may be only heated to about 140° F. and held for a few seconds. At typical thermofoiling temperatures, this film may sag and create holes during vacuum processing. A vacuum may then be applied under the warm film and it may then completely conforms to the rough stonelike texture of the mineral fiber composite. The resultant “ecoart” may be highly wear resistant due to the fact that the print layer is below the clear film layer. The end product also results in an approximate 30% biocontent and a 60% recycled content with the balance of 10% a natural clay.

The biolaminate layer may include one or more layers of the extruded biolaminate material. In producing a multilayer, a heat laminating process may be used to form the layers together into the biolaminate surface layer. Each layer may be the same, may be similar, or may have specific and different functions. Multiple layers of biolaminate may be fused together by heat and pressure in which the material is slightly below the melting point of the biopolymer using hot press systems and reasonable pressures around 50 PSI. Other means of fusing two layers of biolaminate may be used including adhesive double side tapes, heat activated adhesives, solvent bonding, and other methods. Fused together they form a multilayer functional biolaminate that then can be laminated or thermoformedonto a non plastic substrate to form a biolaminate composite assembly.

The biolaminate composite or any layer thereof may be laminated onto a non plastic substrate. Optionally, a paper, non woven mat, woven mat or other forms of backer may be positioned on the back of the biolaminate surface prior to laminating onto a nonplastic rigid substrate. Various fabricators may use simple water based PVA glues in the field for good adhesion of the biolaminate to the non plastic rigid substrates. In addition, this may provide additional functional performance of the biolaminate layer.

In some embodiments, heat activated adhesives may be used for contacting the biolaminate. This may be useful for simple cold press adhesives, such as PVA, that require that the laminate underside absorb water and create a bond without heat. The biolaminate of these embodiments may be completely waterproof on both sides, for example. Thus by the usage of heat processing in laminating the “polar” nature of the PLA is increased and creates a high degree of bond strength required for specific applications. Another suitable method of laminating may be in a hot pressure laminating process using a heat activated or heat cured adhesion.

Laminating may include flat laminating or three dimensional laminating processes. Flat lamination is used currently with high pressure laminates to adhere the laminate onto a wood or agrifiber composite substrate. Flat laminating is based on the application of an adhesive or glue layer onto either the substrate or laminate then using pressure to laminate together. Flat laminating may use many types of glues and processes including both hot press, cold press or pressure sensitive systems. Hot laminating system may allow for improved adhesion between the biolaminate and the substrate.

In order to achieve a multilayer biolaminate surface, multiple layers of PLA film may be typically used, with an optional PET, acrylic, polycarbonate, PEEK, or other high performance plastic as the surface wear layer. In some cases the PLA itself can be used as the top wear layer. To bind all of these layers in a multilayer single sheet biolaminate, thermal fusion may be utilized to create a homogenous sheet. Although the usage of adhesives may be used to bind the layers, thermal fusion may alternatively be used and may facilitate performance in hot laminating post processing of the biolaminate being laminated to a substrate. Roll laminating may be one method of processing, in which two hot rollers heat the material and “nip” the layers it into a uniform fused sheet. Although other methods such as a hot press may be used, hot roll laminating is preferred by being a continuous process and having more control.

Thermofoil laminating or thermoforming is commonly used for three dimensional laminating in which a non plastic substrate is machined into a three dimensional part such as a table top, worksurface, cabinet door or the like. A water based urethane adhesive may be sprayed onto the substrate. By means of heat and pressure using a vacuum or membrane press, the biolaminate layer may be formed to the substrate and simultaneously the adhesive may be heat activated to cure,

Profile wrapping is similar to that of thermoforming (i.e., thermofoiling) but is done using linear processing equipment to create millwork, windows, and other linear components. In this embodiment, the substrate may either be machined from a wood or agrifiber composite into a linear millwork shape. This may also be accomplished by extruding a shape from a natural fiber or mineral with a plastic as to eliminate the machining and reducing the waste from machining. Using a profile wrapping machine, typically, a hot melt contact adhesive may be applied hot to the substrate or biolaminate then pressed using a series of small rollers to form the biolaminate layer onto the linear substrate.

Linear wrapping may be used to apply a thin film onto a wood machined substrate. Typically these films are all made from PVC. With growing concerns over the usage of PVC and its negative environmental effect, this invention provides a truly green option for windows, door components, decking, millwork and other architectural linear components. A biolaminate or biofoil as defined in our previous patent application is produced at a thickness 0.010″ or less that is in the form of a decorative film. The films are slit into the appropriate width in rolls. Various environmentally friendly substrates as defined below are extruded into a final form. These can be in various forms from foamed to solid and typically in the form of a composite matrix. Using a linear wrapping machine a hot melt adhesive typically a urethane is applied in molten form rolled onto the substrates. Before the hot melt glue can cool a series of rollers apply and form the biofoil to the surface using pressure. In some cases the biofoil can be preheated to soften the material to allow forming in complex shapes. The final part is a linear component that can be used for a myriad of building products and components.

In standard laminate worksurfaces, an edgebanding is required. A biopolymer, such as PLA processed below its melting point and in its viscoelastic state similar to producing the biolaminate, may be used to produce profiles such as shaped edgebanding and other support components. Either a tee molding that is mechanically attached to the non-plastic rigid substrate or a flat profile edgebanding that is glued is described within these embodiments. Matching bioedgebanding may be produced using the same biopolymer or biocopolymer system and process to allow for matching aesthetics and performance. In addition, a matching linear profile wrapped millwork product may be produced using the biolaminate surface layer laminated onto a wood, agrifiber or plastic fiber composite extrusion to create an aesthetic matching green system for an entire office or building solution.

Other means of creating a matching edgebanding or matching millworkprofile may be accomplished using pro file extrusion methods of a composite substrate in a continuous linear shape such as millwork. The biolaminate layer may be laminated using a linear wrapping process and a hot melt adhesive to create a myriad of environmental millwork as a replacement for PVC foamed or PVC wrapped millwork.

High pressure laminates typically come with supporting products such as edgebanding in the form of slit laminate or profile extruded linear shapes. In the embodiments of the invention, the biolaminate layer may be slit or cut into strips to be used as matching edgebanding. The “slit” or cut biolaminate layer may then laminated to the edge of the substrate by means typically of a hot melt adhesive with slight pressure. The biolaminate layer edgebanding may then trimmed. The biolaminate surface layer edgebanding may also be printed or extruded with solid colors and patterns.

Some embodiments of the present invention use a novel method and optional compositions to maintain crystallinity of a PLA or other biopolymer through processing and maintain this in the end profile extrusion or sheet components. Embodiments utilize higher shear, which is not recommended by the manufacture of PLA products, and very low processing temperatures typically below that of 320° F. or 300° F. to process the material in its elastomeric state well below its melting point and recommended processing point of 380° F. to 420° F. where the material converts to a fully amorphous material. Conventional processes provide a cloudy extruded component versus a clear and more brittle packaging material.

At this processing temperature, the material may be fully crystallized, but below the temperature and processing parameters to create a full amorphous material. The resultant materials may be cloudy, but have a significantly higher flexibility while still maintaining a high degree of mechanical performance.

By maintaining a crystalline state or partial crystalline state by the process within embodiments of this invention, stickiness of the polymer may be greatly reduced and advantageous properties may be retained for products that may replace PVC in profile and extrusion applications. Also, within the processing parameters of the embodiments of the present invention, the material may have a different rheology and melt index that may allow processing into extruded three dimensional shapes.

Additives may also assist in these embodiments and still maintain the crystalline state of the PLA or PLA admixtures. Nanomaterials, fillers, fibers, proteins, starch, wood flour, wood fibers papermill waste and other materials may increase the nucleation of the PLA and affect the crystalline states to the material. By processing well below the melting point and through the usage of high shear it may be possible to maintain a less brittle state of the PLA and be able to more closely match the desired properties of PVC products and applications requirements. Other nucleating agents, fillers, fibers and materials have been tested with positive results using this novel process methodology.

Sheet biocomposites can be reheated and post formed into various shapes for applications such as sinks and other three-dimensional post formed products. Normal vacuum forming or simple heating the sheet then placing on a mold can accomplish this process.

Shapes can be molded using the biocomposite particles by using inexpensive shaped metal mold being the process does not require pressure to provide the shape. Biocomposite particles are placed into a two-sided mold with excess material in a “sprure” to feed in additional material as the air voids are reduced in the fusion process. In molding cases such as a sink where larger molding shapes are required, smaller sized biocomposite particles provides for higher bulk density of the biocomposite particles thus providing less flow markets to maintain the granite like appearance.

Method for Making a Cellulosic Biolaminate Composite Assembly

Embodiments relate to a product and method for making a biolaminate assembly utilizing a non saturated paper and layers of extruded biopolymer dry films that once a stack of the nonsaturated papers and biopolymer films are subjected to heat, pressure, and moisture, the biopolymer film changes viscosity as to allow saturation and impregnation of the paper and fuses multiple layers together into a monolithic composite structure. This structure may be used for either decorative surfacing, such as by use as a decorative surfacing laminate layer, or structural composite applications. Embodiments relate to a product and methods for making a biolaminate assembly utilizing a saturated or resin impregnated paper layer, in particular a decorative surfacing laminate layer. Embodiments of the present invention include biolaminate assemblies utilizing a saturated paper with substantially no formaldehyde emission. Such embodiments may be used as replacements for high pressure laminates. Another embodiment utilizes standard methods to work with existing form formaldehyde based laminate production processes. A further embodiment may be to improve post forming characteristics without the need of applying pressure during resin production, or expensive modifiers.

Generally, the method may comprise providing a first paper layer, providing a biobased polymer film layer, and providing a second paper layer. The first paper layer and the second paper layer may be at least partially saturated with a biobased polymer, such as from the biobased polymer of the biobased polymer film layer and/or from an additional biobased polymer source. The first paper layer, the biobased polymer film layer, and the second paper layer may be fused under means of heat and pressure to form the biolaminate structure. Fusing may be done at a pressure between about 20 psi and about 1500 psi, for example. In some embodiments, the biolaminate layer, such as a PLA biopolymer, can be in a dry extruded film form.

Various of these steps will now be described in more detail.

Any suitable woven or nonwoven cellulosic paper may be used. Suitable papers include, for example, plain paper, kraft paper, treated paper, wood based paper, recycled papers, decorative paper, printed paper, fiber reinforced papers, glass fiber reinforced paper, thin wood veneers, fire retardant paper, chemically treated paper, ph adjusted papers, or a combination thereof. The cellulosic paper may be a biobased paper from a renewable plant fiber such as hemp, baggase, wheat straw, and corn stover.

Various methods for impregnating the cellulosic layers with a biopolymer may be used. These include composite pressing a stack of at least one non-saturated paper and at least one biopolymer film, direct applying molten biopolymer to non-saturated paper, and saturating the cellulosic papers with a liquid biopolymer.

In composite pressing of a stack of at least one non-saturated paper and at least one biopolymer film, the stack is processed under heat and pressure conditions within a hot press. Temperatures can range from 310 F to 400 F, but not limited to, and pressure ranging from 20 psi to 1500 psi. Residual moisture content of the paper and paper chemistry will have an effect on the time required to fully saturate and impregnate the papers within the press system and effects the dynamic rheology of the biopolymer. This method removes the current process wherein papers are required to be saturated prior to the composite pressing process.

In embodiments using direct application of molten biopolymer, for example molten PLA, the molten PLA may be direct applied using roll coating. Various additives can be blended into either the paper or into the molten PLA prior to coating applications to enhance properties or processing speeds. Various papers layers are placed through a hot melt roll coating machine in which PLA in molten liquid form is directly applied to the paper and ran through chilled rollers. The coated paper layers are then stacked into the desired amount of layers and placed under heat and pressure in a composite press. Temperatures range from 310 F to 400 F and pressures between 20 psi to 1500 psi as to saturate, impregnate and fuse layers together as to create a monolithic structural composite structure.

In embodiments using liquid biopolymer, woven or nonwoven cellulosic paper or various forms of biobased fiber papers may be saturated with a liquid form of PLA or LA. The paper may then be submersed in a bath of liquid LA with a low viscosity sufficient to absorb into the paper. Lactic acid is the precursor to polylactic acid and may be in a low viscosity for in that absorbs into the paper.

The LA saturated paper may then be dried using heat, air or other drying methods commonly used in drying saturated papers. In some embodiments, the surface of the dried, saturated first paper layer may be texturized. Core layers of saturated paper may be plain papers. Surface layer or layers may be in the form of a preprinted pattern, color or image printed by standard means of printing including but not limited to wide format UV digital printing.

Additives may be contacted with the paper or resin, one or more of drying agents, polymerizing agents, peroxides and other crosslinking agents, colorants, ETC and fire retardants.

Once the LA saturated paper is dried, one or more layers may be placed onto a textured paper, metal or composite platen. The platen may impart a texture onto the surface of the final laminate and also provides a uniform cooling process while the laminate is curing and cooling.

In one embodiment, a printed LA saturated paper may be placed on top. The single or stacked layers of LA saturated papers may be then thermally fused into a solid laminate sheet. Temperature range from about 120° F. to over about 300° F. until the LA is fully impregnated into the fibers, layers may be fused or the desired polymerization had occurred.

Thermofusing may be done using a hot platen press with pressure ranging from 20 psi to over 1000 psi depending on the final desired specific gravity or hardness of the biolaminate. In another embodiment, a hot roll press may be used to heat and fuse the layers into a solid laminate.

A single layer of paper may also be saturated and cured using the lactic acid polymer that may be used as a backer layer. In this case, the saturated paper may be produced, then may be thermally fused or adhered to a thin biobased film including a polylactic acid sheet with a color backcoat or digital imaged to produce a decorative laminate. The saturated LA paper provides for a paperback surface that may be easily laminated onto various rigid substrates including particleboard, MDF, agrifiber composites, mineral fiber composites and other types of thin or thick rigid composite structures, thus providing a waterproof and decorative surface option that is completely formaldehyde free.

Another embodiment includes laminating a clear polylactic surface layer and the LA saturated paper to impart a high degree of stain, chemical and wear resistance. In addition, this biobased wear layer may be refurbished with similar processes used in petrochemical polymer solid surface materials. Accordingly, in some embodiments, an overlay layer comprising a thermoset and thermoplastic standard overlay, a mineral plastic overlay, a bioplastic overlay, or a wear layer surface overlay may be provided.

Another method for curing the liquid LA resin saturated paper may be—through the—usage of Ebeam or UV cured technology in which photoinitiator is added to the LA resin prior to the paper saturating process. The saturated LA resin paper may then be placed under an Ebeam or UV light to final cure the material.

Method for Making a Decorative Fused Random Particle Biocomposite

PLA typically has a melt point close to its recommended processing temperature of 390 to 420 degrees F. PLA also has a heat deflection temperature that is lower than most common plastics at a little over 110 degree F. The processing temperatures within this art is below the melting point Tm of the biopolymer. PLA is recommended by its manufacture to be processed above 390 degrees F. At this temperature the material is too viscous to maintain individual particle domains. The process within this art operates based on the heat deflection temperature range where particles soften to an elastomeric state that allows deformation to a minimum energy state without melt flow that would interferes with particle boundaries. Typically, in the case of coated PLA or PLA based biocomposite particles, temperature ranges from just under 200 degree F. to 350 degrees F. are preferred.

Between the heat deflection or glass transition point and the melting point, PLA particles can easily be deformed with minimal pressure or by simple gravity into a minimum energy state or matrix without melting the PLA. This is used within this invention to fuse the polar biocomposite particles containing a PLA matrix resin into a random fractal geometry that mimics natural granite. Within this invention the matrix resin can be a biocopolymer using PLA in combination with a hydrogenated soybean oil or natural wax. The waxes provide lubrication, plasticization, and coupling of the biocomposite particles. A biocopolymer can comprise of 99% PLA to 1% hydrogenated soybean wax to 50/50.

The individual biocomposite particles may be designed using a wide range of various fillers, fibers, decorative materials, colorants, and other forms of smaller particles within the biocomposite matrix. This creates individual particles with a three-dimensional or depth of field look. Typically it may be preferred that these biocomposite particles are not in a uniform shape or have geometries similar to fractured glass or concoidal fracturing.

Decorative Biocomposite particles may be produced by two primary methods that can create a myriad of aesthetic and geometric particle forms. The biocomposite particle may be formed by taking recycled paper and grinding, it into a flocculent fiber matrix. This is similar to that of cellulosic insulation which also can be used and actually preferred due to the addition of fire retardants to the flocculent cellulose.

The cellulosic material is coated by means of spraying a colorant onto the fiber while mixing. The fiber quickly absorbs the moisture within the paint or colorant and the loose fiber creates individual particles. In the coating process method we use various forms of sprayable paint to coat the outside of these particles. The particles are dried to a very low moisture content typically below 0.5%. Various forms of liquid coloring system can be used within this invention including acrylic water based colorants, oil based paints, latex paints, or vegetable oil based paints. It is preferred to use a water based or natural oil based paint to maintain the environmental nature of the product. Natural colorants can also be used in a liquid carrier.

In a secondary process a hydrogenated vegetable oil such as a hydrogenated soybean oil is melted and sprayed onto the colored particles. This further consolidates the fibers into discrete particles. The particles are allowed to cool and are sorted by sizes and colors. Other forms of natural waxes can also be used in addition to or replacing the hydrogenated soybean oils. Natural waxes include, but are not limited to bees wax, vegetable oil waxes, synthetic waxes and other similar materials. This provides two primary functions: to coat the colored cellulosic painted particles as not to regain moisture and to better impregnate the fibers. In addition in further steps, a portion of the wax or hydrogenated oil will be “donated” to the biopolymer to act as a biolubricant/bioplasticizer/biocoupling agent for the final material and resultant biolaminate product. Particles can be separated prior to painting by size using standard screening methods. Each size particle groups can be painted a unique color, then all sizes and colors can be reblended into the biocomposite particle admixture.

The overall random geometry biocomposite particle comprising of a cellulose, colorant and hydrogenated vegetable oil can be made in various sizes and geometries based on the liquid to solids ration of the decorative biocomposite particle. In some cases using lower ratios of liquid colorant to cellulosic fiber leave much of the recycled paper uncoated. This provides a highly decorative look of multicolor in the final product.

The coating process of the liquid colorant and the secondary process of wax or hydrogenated vegetable oil coating consolidates the very low bulk density fiber into a usable material to feed into an extruder. It may be very difficult to feed normal ground newsprint into an extruder due to its fluffy nature. An example would be a low level of ground cellulose (10%) compounded with 90% bioplastic pellets by weight would mean that the 10% cellulose about 15 times the volume of the pellets. Furthermore ground cellulose does not flow and creates additional problems in processing. Sufficient hydrogenated vegetable oil or wax is also used to fully impregnate the fibers. To accomplish this we can add between 1% to 50% by weight a liquid wax to the color coated cellulose. This amount not only impregnates the hydrophilic fibers, but squeezes some out of the fiber during the compounding process that donates to the matrix bioresin system.

By means of this process the cellulose is consolidated from this a bulk density to a higher bulk density which now can be handled by standard processing equipment. The resultant biocomposite decorative particles typically range in size from 0.1″ to over 0.75″ and looks like loosely formed random geometry fiber bundle rather than a uniform particle.

The coated decorative colored biocomposite particles comprising of a colorant and hydrogenated vegetable oil or wax is not uniform in nature by geometry and is not fully mixed. The colorant/wax is more of a coating than a full mixture at this state.

The decorative biocomposite particles or biocolorant system is then metered into an extrusion process at levels between 1% to 30% with a bioplastic or biocopolymer material. The extrusion process heat and blends the materials together. It is preferred to have minimal mixing, shear and heat in the process as not to homogenize the mixture and to maintain is random fractal aesthetics. Various bioplastic or biocopolymer such as polylactic acid, PHA, and other natural bioplastics provide for a good matrix resin and its clear nature provides additional depth of field for the final product aesthetics.

The material is heated until all biocomposite particles fuse together. Being that the PLA within the biocomposite particle is highly polar and the colorant can typically contain various additives or modifiers, the particles fuse together forming distinct boundaries at the particle interface. If the material is melted, these bounder conditions can be mixed and loose the geometry that creates the highly aesthetic value.

The wax donor plays a part in the extrusion process. As the biocolorant is compressed and heated in the extrusion process, the wax melts before the bioplastic can be softened or melted. This impregnates the hydrophilic fibers and donates' excess molten wax to the PLA. The process also maintains a temperature below that of the melting point of the PLA within its viscoelastic state so that the liquid wax is “kneaded” into the elastic PLA. The wax donation provides bio lubrication, bioplasticization, and biocoupling of the colored biocomposite particles and provides unique flow dynamics that enhance the aesthetic nature of the product in addition assist in the mechanical properties of the final products.

In extrusion processing using decorative and functional biocomposite particles, low shear processing may be helpful to reduce any break down of microparticles into a homogenous form of mixture. By maintaining the microparticles using low shear and processing temperatures under the melting point of the PLA we can maintain the aesthetic value of the material.

In extrusion of the PLA biocomposite particles it is important to stay below the melting point of the PLA and process within its elastomeric state above the heat deflection temperature. This also maintains the amorphous nature of the PLA from becoming crystalline. PLA is commonly processed at temperatures well above 390 Degrees F. as to crystallize the PLA and produce a clear film for packaging. Contained within this art, it is important to process well below this temperature range typically between 280 degrees to 360 degrees F. In addition by processing the PLA biocomposite particle with microparticles at this-temperature and in its elastomeric condition we are able to extruded shaped articles ‘or profile shapes in the extrusion process.

Method for Making a Veneer Laminate

A veneer substrate may be in contact with an adhesive layer. The adhesive layer may be in contact with one or more biolaminate layers. The veneer substrate may also be in contact with one or more biolaminate layers. A biolaminate layer may include multiple layers, such as thin films. The veneer substrate may be further contacted with a rigid substrate, for example.

The layers may be laminated together using either a continuous roll press or a platen press with two clear adhesive layers as to allow the wood to show through the top biopolymer textured film layer (biolaminate layer as a film). The adhesive may be either a cold set, hot melt or heat activated adhesive system used for laminating, but would be desirable to be of a clear nature as to show the look of the real wood veneer. It is preferred that a biobased adhesive system is to be used to complete a 100% biobased veneer product.

Another embodiment includes a biolaminate layer (thin film) being tinted to remove a liquid staining process of the wood veneer. Many wood veneers are difficult to stain based on the makeup of the wood species. The film may be tinted with a transparent color either by compounding the tint colorant directly into the film by standard plastic compounding methods or by coating the back surface with a transparent color paint.

Another embodiment is to back print an additional grain pattern to enhance the value of low cost veneers being able to mimic higher cost wood species. The biofilm layer (thin biopolymer film or biolaminate layer) may also be laminated to the wood veneer 702 using various methods that yield various aesthetics. One method includes the usage of a thermofoil machine in combination with a heat activated adhesive system and a thin biofilm top layer. This may allow the biofilm to conformably coat the texture of the wood veneer to highlight the grain pattern of the natural wood. Other methods of laminating the biofilm, wood veneer and backer may be to use various heated flat platen processes with smooth or textured sheets to impart a unique surface texture onto the veneer substrate.

Biofilms typically have a lower molding point than conventional petrochemical polymers. This allows the bioveneer to be 3D laminated and formed over complex contoured shapes with much lower heat thus maintaining the quality of the wood veneer and not discoloring the wood veneer due to excessive heat during the 3D laminating process.

A biopolymer film, including PLA for example, may be extruded into a film in which down stream equipment imparts a specific texture and gloss to highlight the wood veneer appearance or meet specific surfacing performance requirements. The film may be produced in large sheets or roll formats, for example.

The biolaminate top layer may be in a continuous film or sheet product ranging in thickness from about 0.001″ to over about 0.050″. The top layer may also include of a surface texture that imparts specific aesthetics or functional specification.

Non-Biodegradable and/or Softened Biopolymer Profiles

Polylactic acid is classified as a biodegradable or biocompostable polymer derived from lactic acid from corn. Its primary application is for environmental packaging and fibers promoting its biodegradability. When processing PLA, the PLA is processed above its melting temperature which converts the PLA into an amorphous clear plastic. At this point the material is brittle and is degradable under specific conditions.

In some embodiments, a binder may not be used during processing of PLA and a high tolerance PLA crystalline profile may be produced. Through the usage of a viscoelastic process, wherein processing is done using very low shear at temperature well below the melting point of the PLA or modified PLA, a high melt strength is maintained sufficient for profile extrusion and also create a tough “non brittle” part. It is preferred in this process to have some form of “lubricant” that can be either biobased such as a natural wax or oil. Secondly synthetic lubricants can also be used but it is preferred that biobased lubricants are used to maintain the highest degree of biobased content in the products. Lubricants are also found in specific color materbatches found in plastic colorants that also assist in keeping the shear heat inputs low enough to maintain the high degree of crystallinity and melt strength required for this process and products. Also colorants or nucleating agents also have a positive effect to maintain a high degree of crystallinity in the PLA or modified PLA extrusions. Colorants effect plasticizer, potential nucleation, and lubricant.

By the addition of a Lapol or HalStar_bioplasticizers; at high levels a biobased soft touch material may be produced. By maintaining PLA with a lubricant in combination with a viscoelastic process, rigid profile parts that are non biodegradable and have a high degree of crystallinity and toughness may be produced. These non-biodegradable parts may be particularly useful as biocomposite substrates.

By using the viscoelastic process, bioplasticizers from Halstar to process polylactic acid a replacement for vinyl upholstery can be produced. The viscoelastic process also improves the toughness needed for upholstery and offers an environmental solution to plasticized PVC vinyl.

This form of product may not require printing, although a print layer of bioink can be sandwiched between the two flexible PLA layers in which the top layer is a clear. In most cases a colorant can be used to tint the primary film to match yarious vinyl or leather materials. A leather texture can be embossed onto the surface.

A nanocellulosic material can also be added to the flexible PLA blend to increase the strength of the upholstery material.

By using the viscoelastic process with bioplasticizers from Halstar to process polylactic acid a thick sheet of “soft” flexible polylactic acid can be produced that can be slit into strips that can be used as a soft touch edgebanding.

By using the Halstar plasticizer and the viscoelastic process, the resultant polylactic sheet may be softened. This also effects on impact resistance. By plasticizing the material not quite to a full soft touch, the impact resistance higher of the polylactic sheet may exceed that of PVC.

Method of Making a Biocomposite Substrate

Polylactic acid is a commonly used bioplastic currently used for food packaging. It is a very hard and brittle plastic not suitable for the replacement of flexible PVC film or sheet applications. Using methods described herein, PLA is processed below its melting point in its viscoelastic state to maintain a high degree of crystallinity and allow easier processing of a bioplasticizer. Typically current work on PLA additives has focused on impact modification to reduce the brittleness, but this does not have sufficient effect to create the degrees of flexibility required for these types of applications. New forms of plasticizers such as ones from Halstar can be compounded with polylactic acid to the degree to make the polylactic acid soft enough to meet the flexibility or durometer required of this application. The viscoelastic processing method also allows improved processing and maintains a higher degree of toughness in the final product. Typically the amount of plasticizers will range from 10-50% and more preferred around 30-40% in to the PLA in our viscoelastic process. The resultant material has a durometer similar to that of flexible PVC.

Accordingly, in some embodiments it may be useful to have a fairly high percentages of bioplasticizers—ranging from 10% to 50%. Such high percentages are particularly useful in producing three dimensional biocomposite substrates. To produce flexible PVC, powdered PVC is blended with a liquid plasticizer at around 30% liquid plasticizer. This still maintains a powder that can flow into an extruder in a one step processing. In contrast, PLA is pyically produced in pellet form and it is difficult to blend a pellet and liquid together uniformly in a standard extrusion line. By processing of PLA in its viscoelastic state by extruding below the melt point of the PLA, a high degree of crystallinity is maintained and better mixing of plasticizers is facilitated. The extruded PLA further exhibits an overall improvement in toughness. In some embodiments, the process may use a twin screw extrusion system wherein the liquid plasticizer is added with the pellets. A second option id described below.

By the usage of a jet mill manufactured by CCE Technologies can impact mill the PLA and still maintain a low enough temperature to not milt or clump the material. Conventional mechanical milling of plastics such as PLA, induces to much kinetic energy input that clumps or melts the material together not allowing a uniform powder or plugging the mill.

By jet milling using cool compressed air, a fine powder may be produced. In addition, various minerals may be added to the PLA during the jet milling process that allows for an addition grinding medium to assist in grinding and also may add functional value to the final produce. Minerals or mineral blends such as quartz, calcium carbonate, clay, or other minerals added at ratios less than 50% and more than 1% greatly improve the jetmilling process creating more uniform and finer PLA particles. Other blends and sources of minerals can also be used including paper mill sludge from toilet paper mills that already contain a high degree of minerals such as clay and calcium carbonate along with chemically processed cellulosic fiber. This added to the functional performance of the PLA in our flexible product lines.

The various methods for processing PLA to form a biolaminate may be applied to processing PLA to form a biocomposite substrate, including a three dimensional biocomposite substrate. In some embodiments, such biocomposite substrate may be extruded using conventional twin or single screw extrusion systems that heat the plastic, bioplastic or resin binder flowing the material through a shaped die system. Some applications includes shapes for siding, millwork, door components, window components and other forms of linear components. After cooling the substrate may be placed into a linear foil wrapping machine that applies a biolaminate, such as a biofoil onto the surface of the biocomposite substrate by means of heating to form the biolaminate onto the surface. In addition this system may apply a hot melt adhesive, typically urethanes, and applies pressure to the biofoil to form to the surface.

The flexible sheet is extruded using a single or twinscrew extrusion systems wherein the plasticizer is added to the PLA pellets and processed between 300-360 degrees F. well below the PLA's 390 F degree melt point. This maintains a very high degree of crystallinity and improved toughness of the final film. The films range in thickness between 2 mill to over 30 mills based on the requirement of the application. The flexible film is cooled and rolled.

The film then can be printed using a newly developed biobased printing ink derived from corn, soybeans and cotton. The corn portion of the printing ink is based on lactic acid thus the compatibility of lactic acid to polylactic acid is very good. This lactic acid ink was tested on PVC with limited adhesion success. Biobased inks such as ones now available from VuTek, EFI Bioink and Mutoh are all based on the lactic acid chemistry with other bioadditives and biobased binders.

Uses

The biolaminate composite assembly can be made into table tops, desk tops, cabinet doors, cabinet boxes, shelving, millwork, wall panels, laminated flooring, countertops, worksurfaces, exhibit panels, office dividers, bathroom dividers, laminate flooring and other areas may use the system of the biolaminate in combination with a non-plastic substrate and adhesive layer to create a truly “green” solution for the growing demand for more environmentally friendly products.

A biolaminate composite assembly may be made into various forms of cabinet doors that are based on flat laminating, thermofoiled three dimensional, or integrating profile wrapping components and combining all of these together to create various designs of cabinet or passage way doors.

A biolaminate composite assembly may be formed as ecoart and may comprise a heavily textured mineral composite. Various heavily textured mineral composites may be commonly used for ceiling tile applications. Ceiling tiles of various heavy surface textures and composition may be used. Ceiling tiles may typically be fire retardant and thus the above imaged tile or panel meets such specifications.

The biolaminate surface layer can also be plasticized to a high degree using various normal or preferably biobased plasticizers to create a more flexible biolaminate surface layer that can be produced as a wall covering that is adhered onto wall board as a high performance wall covering that may replace PVC vinyl wall coverings. In this embodiment, a secondary non woven cloth may be laminated onto the backside of the biolaminate layer to provide improved performance while maintaining flexibility. The biolaminate layer that is highly plasticized as above, may also be used as a replacement for flexible PVC media for printing.

A biolaminate composite assembly utilizing a PLA biocopolymer biolaminate based on a plasticizer or processing aid additive and the addition of a “nanoquartz” additive to the biolaminate surface layer provides for a high degree of wear and temperature resistance sufficient to be used in countertop applications. Currently food grade surfaces consist primarily of HDPE and stainless steel. Stainless is expensive and HDPE may trap food or liquids in scratches or cuts within the surface. The “nanoquartz” technology may provide good performance and durability of the surface. A biolaminate laminate assembly integrating quartz may also provide a lower cost option for expensive granite and other solid surfacing composites for kitchen countertops, tables, and other higher performance areas. These forms of biolaminate layers may be either flat laminated or thermoformed into three dimensional worksurface for kitchen and other forms of countertop applications.

Decorative fused random particle biocomposites may be useful for Applications kitchen or commercial countertops, worksurfaces, flooring, wall tiles, plaques, awards, and other commercial applications can use the materials from this invention as a direct replacement for solid surfacing or other forms of decorative material applications. In addition due to the high degree of UV stability of the PLA, exterior applications such as signage, architectural panels, tables, and other applications are viable.

Three dimensional biocomposite substrates may be used for a variety of purposes. General industries include commercial baseboards, soft touch edgebanding, door sweeps integrating both rigid and soft modified PLA, corner bead for sheet rock, and other PVC replacement profiles. Other specific examples for 3D biocomposites include a 3D composite molded table integrating a biofoil, a countertop molded integrating a biocomposite and biolaminate, a biobased millwork integrating a biocomposite and biofoil, a water proof flooring integrating a biocompósite and biolaminate, a 3D cabinet door integrating a biocomposite and biofoil, a 3D passage door integrating a biocomposite and biolaminate (FR), a 3D desktop/worksurface integrating a biocomposite and biolaminate, window components integrating a hybrid composite and biofoil with high UV resistance, and a siding component integrating a foamed plastic or biocomposite with a UV resistant biofoil.

Flexible Sheet Products and Signage—In some embodiments, a biocomposite substrate as provided herein may be used as a replacement for flexible decorative PVC products in use, for example, as decorative flexible plastic products including signage, wall paper, and upholstery. A biocomposite substrate further may be printed with a biobased ink to provide a flexible, green, decorative signage. In such embodiments, a flexible PLA sign may be formed comprising a flexible polylactic acid film using a biobased plasticizer creating a flexible film in combination with a lactic acid based printing ink.

Although PLA is a biopolymer used for packaging, it is not truly biodegradable, but compostable under very specific commercial compositing processes. PLA is actually a very good exterior surfacing solution due to its inherent UV resistance, water resistance, and high degree of stain resistance as compared to petrochemical polymers. The biolaminate of the embodiments of this invention now allows for a decorative layer surfacing that can be laminated onto such structures providing a highly aesthetic and highly function component or product.

Currently, PLA is very difficult to extrude into profile shapes due to its poor melt stability, high melt index, and other factors. Embodiments of this invention describe a method to extrude PLA or other biopolymer into shapes and compositions that assure that the material will not degrade in various longer term commercial profile extruded applications and products. Secondly, embodiments of the inventions describe methods of processing that provide high quality profiles and material compositions that may directly compete with or replace current hazardous plastics such as PVC in architectural, commercial and industrial markets. The profile extruded PLA or PLA biocomposite can be used as a substrate for the biolaminate surface layer or be colored to match the biolaminate. This biolaminate composite system of merging an environmentally friendly substrate with a biolaminate derived from rapidly renewable resources provides a true environmental solution for future worksurfaces and other applications where HPL or PVC thermofoil components are commonly used.

### EXAMPLES

### Example 1

PLA pellets were placed into an extruder with temperatures settings 20° F. above the melting point at 420° F. which is also recommended by Natureworks for processing temperature. The material poured out of the die like honey sticking to the die. The temperature was dropped to 310° F., over 80° F. lower than its melting point. The RPM was increased to add shear input to the material. The resultant shape held its complex shape with minimal distortion.

### Example 2

PLA pellets were placed into an extruder using a sheet die with processing temperatures of 380 to 420° F. and a clear sheet was produced. The sheet was brittle and easily cracked when bent. The resultant sheet was flat laminated onto a wood particleboard using a heat activated glue under heat and pressure using a hot press with temperature of 150° F. and pressures under 50 PSI. The material showed very good adhesion to the substrate.

The same sheet as above was laminated using a cold laminating method commonly used for HPL using a PVA and cold press laminating method. The PLA biolaminate sheet did not have any adhesion to the substrate and was easily pulled away.

PLA pellets were placed into a open twinscrew extruded and processing temperatures were lowered to 320° F. and material pulled out of the extruder through the vent before the die section.

PLA was placed into an extruder and processed at temperatures below 330° F. well below the melting point using a sheet die. The resultant film was cloudy but had very good melt strength. After cooling it was very apparent that the material was more flexible and had better properties. The thickness of the biolaminate was 0.015″

The resultant sheet from above was hot laminated onto an agrifiber substrate comprising of wheatstraw using a heat activated glue and pressure. The resultant bond strength was very good and in adhesion tests fiber was being pulled away from the particleboard sticking to the biolaminate showing that the adhesive bond was better than the internal bond of the wheat particleboard.

The resultant sheet of biolamiante was then placed into a membrane press with a machined three dimensional substrate wherein the substrate had a heat activated uretane preapplied. A temperature of 160° F. with less than 50 PSI was applied for over two minutes. A comparison test using a PVC film of 0.012″ with a chemical solvent primer to improve adhesion was also membrane pressed using the same substrate, glue and method. The forming of the biolaminate showed equal stretching and forming ability as compared to the PVC. Both the PVC and biolaminate samples were tested in regards to adhesion and were equal in bond strength even with the biolaminate not having a chemical primer to promote adhesion.

The biolaminate film was reversed printed using a solvent inkjet system. The initial ink bond seemed to be sufficient by means of cross hatching the surface and performing a tape peal test. The reversed printed biolaminate was then thermofoiled using heat and pressure in combination with the heat activated urethane adhesive wherein the ink layer was in contact with the laminating adhesive layer and substrate. After processing, a peal test was done. The ink separated from the biolaminate film not having sufficient bond strength. A second test was done wherein the surface of the biolaminate was treated with a solvent chemical before printing. Although improvements were seen in adhesion, it was not sufficient for this application.

A clear biolaminate was direct top printed and coated with a clear liquid topcoat of urethane. The topprinted biolaminate was hot laminated onto a substrate. The bond between the clear biolaminate and substrate was sufficient were fiber tear out was seen on the substrate.

A UV cured screen printing ink was applied to the backside of the clear biolaminate or reversed printed. The biolaminate was thermofoiled using heat and pressure with a urethane heat activated adhesive with the printed side in contact with the adhesive and substrate layer. The adhesion was significantly improved over the standard solvent ink printing process with fiber tear-out of the substrate.

Two three dimensional cabinet door was machined out of medium density fiberboard in the shape of a classic raised panel cabinet door. The first door was processed in a membrane press and standard heat activated thermofoil process using a PVC thermofoil of 0.010″. Press time was 2.5 minutes with 50 PSI at a temperature of 170° F. The second door was processed to the same methods only using a biolaminate surface layer to replace the PVC film. The resultant forming process was surprisingly the same with the same stretching and forming nature of the PVC. Although the PVC had a primer to promote adhesion on the backside and our biolaminate did not, we seen very similar adhesion to the substrates as measured by peal testing. The pull down on the edge of the cabinet door due to the forming process also was the same between the PVC and biolaminate.

A PVC film and biolaminate surface layer were thermoformed onto a three dimensional cabinet door shaped substrate using the same urethane adhesive. Both the PVC and biolaminate were subjected to independent testing according to high pressure laminate standards (NEMA LD3). The resultant data shows that the biolaminate had improved stain resistance, improved tabor wear resistance, and improved mar resistance than the standard PVC decorative surfacing product.

A piece of WilsonArt standard grade high pressure laminate was laminated to a wood particleboard substrate using a contact adhesive. The biolaminate sheet was also laminated to the same wood particleboard using the same contact adhesive and subjected to independent testing in accordance with NEMA LD3 requirements. In this test the biolaminate had over 5 times the impact strength, improved stain resistance, over 2 times the scratch resistance, and other performance improvements.

Different results after secondary heat test was done to evaluate the change in state of the PLA as it was subjected to multiple heat histories. The PLA film produced at a temperature below its melting point in its viscoelastic state at 340° F. was produced in a 0.010″ thickness film. The film was reversed printing using a UV cured ink system and a direct printing inkjet system. The samples were broken into two groups and group I samples were tested for impact, hardness, and scratch resistance. The second group of samples were hot laminated using a membrane press and a thermally activated urethane for 2.5 minutes at a temperature of 170° F. until the glue was cured. These second group of samples were tested directly against the first group. The second group showed a harder surface with improved scratch resistance, but lower impact resistance.

A wood bioplastic profile extrusion was produced at a temperature between 310 to 320° F. with about 20% loading of wood fiber creating a linear shaped piece of millwork. The biolaminate surface layer was heated with a heat activated adhesive applied to the backside of the biolaminate surface layer and compared to PVC films processing using the same method. The biolaminate surface layer had very similar adhesion and formed surprisingly similar to that of the PVC film.

A 3M contact adhesive used for laminate was sprayed on the back side of the biolaminate surface layer and onto a flat wheat board agrifiber substrate. After a minute to flash off any volatiles, the materials were laminated together using pressure from a roller system. A second sample of PVC decorative film was also used on a second sample. The biolaminate had an improved adhesion.

### Example 3

A soybean wax was added to the PLA at 5% and extruded through a profile die. The temperature was dropped to 290° F. and the material was a smooth high integrity shaped with good melt strength sufficient to hold a profile shape. Shear was increased and the shape was improved and smoothness of surface was also improved. The hot shaped article was pulled onto a conveyor belt with no changes in shape from the die.

### Example 4

PLA and a hydrogenated soybean wax supplied from ADM was compounded into a biocopolymer of a flexible nature with ratios of PLA to Soy of 95:5. The resultant compound was then re-compounded with various powdered non halogenated fire retardants at various levels. Mag Hydrox, Alumina Tryhydrate, and ammonium phosphate were all added from levels of 10% to 50%. A strong reaction took place with the MH and ATH materials that created difficulty in mixing and would form layers within the material. The Amon phos material blended well and formed a more homogenous and more flexible material based on various loadings.

### Example 5

PLA was compounded at a temperature below its melting point and within its viscoelastic state around 310° F. Glycerol was added at various levels from 1 to 20%. The resultant material was a homogenous flexible materials. A second test was done wherein PLA was heated over its melting point of 400° F. The same levels of glycerine were added. The glycerine was highly volatile and released significant smoke due to breakdown and created a non homogenous material and was difficult to compound into a homogenous material.

Wheat straw strands of an average length of ¾″ and less than 0.020″ in width were compounded with PLA and a soybean wax wherein the PLA to soybean wax was at a ratio of 95/5.5% and 10% addition of the wheat strands were compounded with the biocopolymer at a temperature within the viscoelastic state of the biocopolymer of 310° F. The material was homogenous, did not smell, and had good impact resistance. A second test was done using the same materials where the process was taken above the required melting point of the PLA of 400° F. The fibers did not interact with the biocopolymer well and significant browning and cellulosic degradation was seen. In addition the material showed signs of burning and clearly had a very negative smell.

PLA and EVA were compounded at a temperature of 310° F. A sample of biodac (papermill sludge particles) were colored by simply dying the particles and dried. The biodac was compounded at 20% with the biocopolymer at a temperature of 310° F. The resultant material had a unique aesthetics and was a tough high impact material. A second process was done using the same materials at a processing temperature above the melting point of the PLA. The resultant material showed signs of degradation and burning. The resultant material was highly brittle with minimal impact strength.

### Example 6

PLA was placed in pan and put into an oven at a temperature over 400° F. Five samples pans were placed into the oven with PLA. An addition of 10% of plasticizers was placed in each pan. Plasticizers and lubricants were glycerine, wax, citric acid, vegetable oil, zinc stearate. After the PLA was molten the materials were mixed. During the heating virtually all of the plasticizers lubricants started smoking heavily with significant smell and starting to boil or degrade. The materials could not be mixed together. The same test was done only at a temperature of 300° F. over 80° F. below the melting point of the PLA. The plasticizers did not smoke, boil or degrade and were able to be mixed into a more homogenous material. Zinc stearate was the worst of these materials with the soybean wax being the easiest to blend.

### Example 7

PLA and biofiber functional colorant system will be meter directly into the single screw sheet line wherein a high level of dispersion with low and medium shear input is required. Processing temperatures were set well below the melting point of the PLA which is over 380° F. In this test the heating sections where set at 310° F. to 315° F. at the die exit. The material was not sticky and had sufficient melt index to create a profile. The material was not clear as processing PLA at or above its melting point, but semitransparent maintaining its crystalline nature and had more flexibility and impact resistance. Cooling roll temperature we evaluated between 80° F. to over 200° F. We found that the material cooled significantly quicker due to the lower processing temperatures and required heating the rollers.

### Example 8

PLA 2002 from Natureworks in pelleted form was compounded with 5% SWL-1, a congregated soybean wax products from ADM. Compounding was performed in a Brabender twin screw at a temperature of 300° F. over 80° F. below the melting point of the PLA. The material came out of a round die holding a good solid shape and was cooled. The material was a very opaque milk white color and the resultant material was able to be bent without breaking with a similar feel and performance t that of polyethylene.

A second compounding run was done increasing the amount of SWL-1 to 10% with 90% PLA. The material was lower in viscosity and processing temperature was decreased until the material held its round shape. Again the material was very opaque and white.

A third compound was done adding screened wheat fiber wherein a water based colorant was sprayed on the wheat fiber then dried. The colorized wheat fiber was compounded with 90% PLA, 5% SW1 and 5% colorized wheatfiber. To our surprise, the material was clear to semitransparent with a deep three dimensional look with randomized color fibers. The clearer PLA/SW was slightly tinted to the color of the wheat, but still maintained a transparent depth. The material was not as brittle as neat PLA and actually was similar in flexibility as our first run of 95% PLA and 5% SW1.

### Example 9

PLA was compounded with 10% SW1 and 10% ground sunflower hulls in which the ground hulls were screened to remove the fines below 30 mesh. The resultant material was extruded into a sheet and a texture was imprinted on the hot material. After cooling the material showed a random flow decorative pattern. The material was placed in water and we observed the water beaded up on the surface of the material.

### Example 10

PLA was compounded with a standard magnizume hydroxide fire retardant and extruded into a test bar. The test bar was very brittle and could be easily snapped by hand with minimal pressure. A second compound was done where 10% SW1 was added. The resultant material had good impact and could be bent.

### Example 11

Wheat fiber was compounded with SW1 at a 50%/50% ratio at a temperature of 300° F. and mixed. The resultant material was cooled then granulated into small particles. The compound of wheat and SW1 was then dry blended with PLA pellets and compounded at 310° F. producing a flat test bar.

### Example 12

Soy Wax SW1 was melted at a temperature of 300° F. in a 100 gm batch. An equal weight of wheat fiber was added and mixed. The soywax quickly impregnated the wheat fiber and left the fiber in a free flowing state. The impregnated fiber was lain out in the mat and pressed. Water was dripped on the top of the mat in which the water completely beaded up on the fibrous mat.

From this it was determined that roughly a 50/50 ration of soywax to fiber based on a specific bulk density and fiber geometry would fully impregnate the fibers. The admixture of 50/50 soywax/fiber was added at a 10% ration with PLA and compounded. The wax on the outside of the fibers where blended with the PLA and provided for a compatible interface. Only a small amount of wax was mixed into the clear PLA. The soywax at room temperature is an opaque white material. The resultant PLA and SW/impregnated fiber was still clear to semi transparent.

### Example 13

A separate experiment took just the soywax at 5% and PLA at 95% and compounded the two together using a Brabender compounders. In this test the resultant material was opaque and milky white color. Thus we see that the addition of fiber allowed impregnation of the molten soywax prior to the PLA reaching a appropriate viscoelastic state to allow merging of the soywax/PLA system due to the transparency of the final biocomposite matrix.

### Example 14

Sugar Beet pulp & Sunflower hulls—Ground sugar beet pulp and sunflower hulls were taken from a regional agricultural processing plant and gently ground or broken into fibers. The materials were screened with the resulting material in a range from 30 mesh to 4 mesh. The particles of sunflowers where a linear geometry wherein the sugar beet pulp were more of a uniform size, but random shape. A dye used in clothing was used to soak the fibrous particles then dried to fix the colorant. The two colored fibers where metered at a 10% rate with 10% soywax and 80% PLA into a brabender compounding system. As soon as the material hit the hot screw feed section the soywax melted and started to wet out the fibers even before entering the barrel section while the PLA was still in its hard state. Compounding temperatures where maintained well below the melting point of the PLA (PLA melting point at 390° F.) wherein the processing temperature was 90° F. below the melting point at 300° F. The resultant material was a uniform mixture that was not brittle and had a unique three dimensional nature. The exit of the compounder was shaped into a high tolerance rod. The exiting material held is shape with a high degree of tolerance.

### Example 15

BioDac—A sample of BioDac was purchased from GranTek Corporation in Wisconsin which is a form of waste papermill sludge that has been compressed and dried forming small spherical balls with a mesh size of between 15-30 mesh. The BioDac was colored using a water based colorant and multiple colorized batches were produced. The colored biodac was compounded at a 20% level with 10% SW and 70% PLA. Compounding was done using a Brabender twin screw at a processing temperature of 310° F. The resultant material was then reheated and pressed into a composite sheet. The material very closely represented a solid surface looking material. Samples were submitted into a water bath for 24 hours and was water proof with no uptake of water measured.

### Example 16

PLA was compounded with long fiber glass at levels of 2% to over 30% at a temperature below the melting point of the PLA (315° F.). A second test was done using the same ratios at a temperature above the melting point (400° F.). A second test was done wherein 5 and 10% addition of soybean wax was added.

### Example 17

A biolaminate sheet comprising of PLA and soybean wax that was processed below the melting point of the PLA was taken and reheated at 200° F. A MDF substrate was formed into a shaped article and an adhesive was applied. The hot biolaminate was pushed and formed onto the substrate and allowed to cool. The resultant material showed a high level of adhesion and very good impact resistance.

### Example 18

A piece of WilsonArt high pressure laminate was adhered onto a particleboard substrate using recommended adhesives. The biolaminate of a similar thickness was adhered to a matching particleboard using the same methods and, adhesives. A hammer was dropped from 5 feet onto both samples wherein the edge of the hammer head impacted the samples. The HPL showed signs of cracking at the edge of the impact hit. The biolaminate showed no signs of impact at all.

### Example 19

a piece of an agrifiber composite produced from wheatstraw were cut into 3 samples. The first sample was stained with a common wood stain to a dark cherry color. The wheat stain was very dark and “blotchy” covering and hiding most of the natural fiber appearance. A biolaminate surface was extruded in which one was a clear and the second run included a transparent dye colorant. The biolaminate sample containing a dye was then laminated using a clear adhesive onto the second non stained wheatboard sample. The clear biolaminate was printed using a transparent UV cured ink on the backside then also laminated to the third piece of wheatboard. In looking over the appearance of the three samples, the wood stain piece was no visually acceptable and did not show the desired wheatboard texture. The agrifiber clearly stained very different than a natural wood. The second sample with the dye extruded into the biolaminate surface clearly was the same overall dark cherry color, but the pattern of the wheatboard was very clearly defined. The look was also very deep due to the optics of the dye containing biolaminate layer. The UV transparent printing was near the appearance to the dyed biolaminate with similar color and optics still showing the individual fiber nature of the wheatboard and providing a good stained color. Another similar test was done using real wood. Both the integrated dye and the transparent printed biolaminates maintained a better aesthetics of the wood grain than the liquid staining process and provided a single processing step to finish the wood as compared to the two step process of staining and finishing typically done using wood.

### Example 20

A clear or semitransparent polymer film of a polylactic acid was extruded using standard extrusion equipment and methods. The downstream cooling equipment was modified to include a textured roller to impart a specific “crystal texture” and “a gloss level's milar to that of a common high pressure laminate (12 degree). The biofilm thickness ranged from 0.005 to 0.040” during extrusion runs. The film was not post treated. The back side of the film is coated with a water based latex paint by simple roller methods then dried for 4 hours.

The back colored plastic laminate was then glued directly onto a 3D substrate by means of a thermofoiling process using a water based heat activated adhesive. Rigid substrates included MDF, particleboard, agrifiber board, gypsum board, mineral fiber bonded board, hardboard, cement fiber board, wood plastic composite board, and other rigid substrates.

A simple peel test was done by cutting into the biolaminate surface and pulling it from the substrate. The film showed very good adhesion wherein the fiber of the MDF substrate tore away and remained on the latex coated biofilm.

### Example 21

A PET film from a standard extrusion distributor was obtained. The film was coated with a latex paint and dried. The backpainted PET film was then hot laminated’ using the thermoforming process above. The adhesion of the PET was very poor and we saw separation between the PET and latex paint layers with no MDF fiber remaining on the backside surface as seen in Example 20.

### Example 22

A modified latex paint wherein an addition of an intumescent powdered fire retardant was added. The paint was then applied by rolling methods to the backside of the textured clear PLA film and dried. The FR painted film was then laminated by means of thermofoiling onto a rigid substrate of MDF. The part was then subjected to direct flame. The PLA surface did not smoke at all and quickly disappeared exposing the intumescent latex which then started expanding and created a fire barrier. After 15 minutes of direct flame the sample was then removed and the intumescent latex coating removed. The MDF sample showed no sign of charring or burning with the biolaminate protecting the wood based MDF from the direct flame.

### Example 23

An extruded film of PLA was produced at a 0.010″ thickness. During extrusion a textured roller imparted a texture and gloss level on the film. On the back side of the film, a direct digital image was printed using a wide format digital printing system. In this example the print pattern only covered less than 50% of the backside surface allowing the paint color to show through. In this example a gold color “web” pattern is printed.

On top of the backside print layer, a colored latex paint was applied by means of rolling, spray or other common methods to apply latex paint.

The biolaminate assembly was then placed into a thermofoiling machine with a machined substrate that had been sprayed with a water based heat activated adhesive sprayed on the surface of the substrate. The biolaminate was then heated and a vacuum and/or pressure was applied to conform the biolaminate to the substrate. In addition the heat activated the adhesive. In addition it was found in this test that the latex paint layer had improved adhesion due to this additional heat step.

The resultant surface component was highly aesthetic with a multicolor image wherein the back latex color provided the field color in the pattern.

### Example 24

The biolaminate including a thin sheet of PLA, PHA or cellulose acetate and a clear or semitransparent form was back coated with various commercial paints. The preferred method was to use a latex house paint that is applied to the back side of the clear biolaminate film. In this case the clear film provided a protective layer for laminate applications and the usage of simple latex paint provided sufficient adhesion and allowed the process to better match designer color needs in the market. The “reverse painted” film was either 3D thermoformed using similar methods as described above or was laminated to a saturated paper (commonly a latex and/or acrylic saturated paper) by means of a glue line.

### Example 25

One Example was a 0.010″ clear film of PLA in which the top surface of the clear PLA film was textured to a specific gloss and texture. The backside of the film was coated with a standard latex indoor house paint using spray, brush or roller methods. The solid color biolaminate sheet was then laminated to 3D substrates of MDF, particleboard, or agrifiber composites wherein the substrate was sprayed with a water based heat activated adhesive and heat. The 3D forming was typically done using [meat and a standard thermofoiling process that used pressure and/or a vacuum to pull the biolaminate sheet to conform to the specific 3D shape of the substrate and permanently adhere the biolaminate to the substrate.

### Example 26

Another Example was a 0.005″ clear film of PLA in which the top surface of the clear PLA film was textured to a specific gloss and texture. The backside was painted using a standard latex paint. A 0.010″ latex saturated backer paper was then adhered to the backside of the biolaminate assembly by means of a glue line. The glue line may include a heat activated, pressure sensitive, chemical bonding, or heat/pressure activated system. The resultant 0.015″ biolaminate now having a latex saturated backer was laminated to other flat substrates such as wood particleboard, MDF, and agrifiber composites to produce a replacement decorative panel that may be produced into cabinetry, casegoods, tables worksurfaces, shelving, and other building components.

### Example 27

Another Example was a 0.010″ clear PLA extruded film textured on the top surface to meet a specific gloss and texture and then a direct digital image with a simple pattern was printed on the backside of the film. A latex paint was then applied over the back printed side. The top surface then showed both the printing and the background latex paint color. The biolaminate was then either directly laminated to an rigid substrate, laminated to a saturated paper which can secondarily be laminated to the rigid substrate, or 3D formed using a thermofoiling process and heat activated process and adhesive.

### Example 28

Another Example was where a 0.010″ clear PLA extruded film was textured on the top surface to meet a specific gloss and texture and the backside was digital imaged and/or painted with a latex paint or other solid paint coating. The biolaminate was then optionally laminated to a thin saturated paper. The biolaminate strips were then laminated using a linear wrapping process to a 3D linear shaped composite. The linear 3D composite was a real wood, wood, papermill sludge, or agrifber composite, foamed plastic or metal extrusion. The biolaminate strips were then laminated to the 3D linear shaped composite by means of a glue line. The glue line may be a hot melt adhesive, chemically reacted adhesive or other forms of adhesives commonly used for linear wrapping. The resultant biolaminated linear extrusion may be used for either exterior or indoor needs such as, but not limited to wridw profiles, millwork, siding, flooring strips, moldings, decorative profiles, and other linear 3D forms. The high degree of UV resistance in biopolymers due to their lack of hydrocarbons found in petrochemical products provide for an excellent natural UV resistance for exterior products.

### Example 29

A mixture of wheatstraw and a plastic binder was pressed into a 3D shape wherein the ratio of plastic to wheatstraw was approximately 50:50. The composite shaped was pressed using 500 PSI in a molding press. Before the part was fully cooled a water based heat activated urethane was sprayed onto the surface of the molded substrate. Using a membrane press, a decorative biofoil of 0.010″ printed using a corn/soybean ink was applied and formed over the surface. The membrane press was set at 160 F degrees and placed under pressure (approx 30 psi) for over 2 minutes. The resultant material had very good adhesion between the biofoil and biosubstrate and formed uniformly over the entire 3D surface.

### Example 30

A mixture of papermill sludge and PLA was extruded at a temperature lower than that of the melting point of the PLA (320 F) wherein 20% paper mill sludge was added to the PLA and into a common millwork shape. The shape as then ran through a linear wrapping system wherein a hot melt urethane adhesive was applied and immediately a biofoil was applied at a 0.010″ thickness. The biofoil was preheated using hot air. The wrapping machine applied pressure by means of independent rollers to form and shape the warm biofoils to the final shape of the millwork piece. After cooling the biofoils showed very good adhesion to the substrate.

### Example 31

A foamed PVC plastic in the shape of a linear millwork baseboard was coated with a water based urethane and air dried for 30 minutes. A 0.010″ decorative biofoil was placed on the surface and placed into an oven. The Biofoil softened and formed around the foamed PVC piece at a temperature not to distort the PVC, but soften the biofoils and activate the adhesive (190 F). The resultant part had very good adhesion in peal tests and formed accurately to the shape of the millwork piece.

### Example 32

Regrind PLA from blow molding bottle production representing a particle size range from ⅛″ to less than 0.1″ that was in the form of random particle geometry was separated into two groups. A metallic copper paint was sprayed on the surface of one group of particles and a black paint sprayed on the second group. The bioplastic particles were then blended together. The admixture of multicolor particles were then placed into a sheet mold and into an oven at 370 degrees F. for over 1 hour. The material was then cooled to room temperature and removed from the mold. The resultant material was fused together with no air voids, but maintained individual particles and particle boundary conditions for each biocomposite particle. Each particle was also deformed in while being in an elastic state wherein the color coating “'cracked” to show a novel aesthetic appearance.

### Example 33

Paper mill sludge in the form of “balled” materials (BioDac) was blended while a water based colorant was added during mixing. The colorant coated the paper mill sludge in a non-uniform manor due to the difference of cellulose to clay ratios within each individual particle. This created a multicolor admixture. Neat PLA was extruded in a brabender extruder while 20% of the multicolored paper mill sludge was added. Low shear and heat lower than the melting point of PLA was used to maintain the individual balled structure of the paper mill sludge. The resultant material was ground into random geometries using a standard knife grinding system used in the plastics industry. The biocomposite particles were placed in a sheet molded and heated to 390 degrees F. then cooled. The resultant material also had distinct particle boundaries and surface microvoids simulating natural-granite. The paper mill sludge microballs were completely coated and the surface was a microlayer of the PLA biopolymer. The material was placed into water and was water proof with a hard surface.

### Example 34

A metallic copper paint was sprayed on regrind PLA in which the tops and sides of the particles were covered. The material was placed into a sheet mold and heated to 380 degrees F. for 1 hour. The material was cooled using cold water. The particles deformed in to solid with separate particles and sharp boundaries between particles. The coating “crackled” on each particle creating gaps within each particle to show the clear PLA. This created a two level optical pattern that looked like a metal foil.

### Example 35

PLA was extruded with paper mill sludge wherein the paper mill sludge was coated with a powdered fire retardant prior to extrusion. The resultant biocomposite particle were extruded and ground into random geometry particles containing the powdered fire retardant and paper millsludge in a non uniform nature with particles and “swirls” apparent in the biocomposite particles. The particles were placed into a mold and heated to 390 Degrees F. The resultant material was then subjected to fire by means of a torch. After the torch was held on the part for 1 minute it was removed. The material did now show any signs if liquid mobility and the flame went out by itself in less than 15 seconds.

### Example 36

Alumina was coated with a water-based colorant wherein the particles of Alumina were approximately a 30 mesh size. The alumina was extruded and mixed with PLA at a temperature lower than the melting point of the PLA and with very low shear as not to fully mix or break down particles. The resultant material was ground using a knife grinder into random particles of size and geometry. Two separate batches of separate colors biocomposite particles were produced. The two color biocomposite particles were dry blended. One batch was placed in a thermal compression molding press and the other batch into the sheet mold that was placed into an oven. Although the material in the press formed a sheet, flow marks were seen and uneven melting was observed. Temperatures for both tests were at 350 degrees F. The material in the sheet mold only under gravity deformed info a solid, but individual particles were more defined and exhibited a look closer to granite. The material had very good burning characteristics as once submitted to flame for a minute after removal of the flame the fire self extinguished within 15-20 seconds. The alumina also provides for a harder more scratch resistance surface when dragging a weighted sharp object over the surface of the alumina biocomposite as the neat biocomposite.

### Example 37

PLA was extruded into a rod and then after changing dies into a flat bar. While the hot PLA was coming out of the extruder a paint was applied to the surface of the material. The material was then ground into random geometry particles. The material was placed into a sheet mold and oven. The resultant material looked very different from other biocomposites tested wherein the single sided coating deformed, but uncoated side shown a depth and transparency in seeing the deformed shapes.

### Example 38

PLA with multicolor-coated paper mill sludge was extruded together and formed into a ⅛″ extruded sheet. The material looked surprising like a Corian solid surface with uniform particle distribution. It did not look like the random particle geometry of the other biocomposites or natural stone, but clearly matched a standard Conan color.

### Example 39

PLA was ground into a fine particulate or powder and was blended with silica particles ranging from 1/16″ to less than 0.05″ and placed into an oven at 390 degrees F. The bottom of the mold was heated first allowing a flow layer on the bottom of the mold of only the PLA. After one hour the mold was cooled. The material was very hard with exceptional surface. A second run was duplicated only spraying the silica sand with colorant. Additional tests were done with silica levels at 10%, 30% 50% and 80%. At levels higher than 10% the material required a diamond saw for cutting. In further experiments with silica were tried with larger particles and various sized particles of silica and other minerals.

### Example 40

PLA was compounded using a ceramic powder used in clear coatings for hardwood flooring at a 10% level. The resultant material was ground into random particles and coated. The biocomposite particles were clear to semitransparent inside and pigmented for the coating. After thermal fusion in an oven at a temperature less than the melting point of the PLA, the material was cooled and sanded. The material was significantly harder to sand and had a noticeable improvement for scratch and wear resistance.

### Example 41

Cellulose waste paper was mixed with a clothing dye and water. The fibers were then dried. The colored fibers were compounded at a low percentage into the PLA as to show a semitransparent and random “fibrous” nature to the material. The material was ground into individual random particles. A second batch using different color cellulose was produced. The two colors of biocomposite particles were mixed and thermally fused into a solid surface material.

### Example 42

A biocomposite particle was produced using PLA and a coated papermill sludge by compounding and producing into an extruded form. The form was ground into individual random shaped biocomposite particles by means of a plastic grinder: Using a low shear extruder at a temperature of 320 degree F. (over 70 degrees lower than the PLA melting point) we extruded a shaped object profile used for edgebanding applications. The material had a three dimensional look and colorant was not needed to provide the overall color appearance of the material. The particle of paper mill sludge was apparent within the semitransparent matrix to provide a look similar to that of a solid surface material.

### Example 43

A biocomposite particle was produced using PLA and distillers syrup with corn hulls using a twin screw compounding system. The hulls were left: in their original size and shape. The material was ground into biocomposite particles. The particles were extruded into a formed shape using a standard twin screw extruder at a processing temperature of 300 degrees (90 degrees below melting point) The resultant material had a soft fibrous texture with pleasing aesthetics from the random geometry of the corn hull fibers. Part of the aesthetic look was that the material surrounding the fibers was semitransparent in nature, but not clear.

### Example 44

A biocomposite particle was produced using PLA and a bioplasticizer of soybean wax derived from soybean oil. Multicolored coated papermill sludge was compounded with the PLA and bioplasticizer to create a soft, but semitransparent elastomeric biocomposite particle. These particles were fused into a sheet mold in and oven at a temperature of 300 degree F to form a solid, but where individual particles boundaries could still be seen. The material was flexible and had a good slip resistance.

### Example 45

A cellulose insulation material was blended in a mixture while a liquid colorant was sprayed onto the material. The bulk density of the material was quickly increased the volume of the material was cut in half with the addition of equal weight of liquid colorant. The material was then dried. The material was then coated with 20% of a molten liquid soybean wax made from a hydrogenated vegetable oil then cooled. The resultant colored biocomposite particle was coated, but not fully as to leave some of the fiber its natural color. The material was then compounded at a temperature of 320 F where 10% of the colored biocomposite particles where compounded with 90% PLA/Soybean wax biocopolymer. The resultant material was formed into a sheet or biolaminate samples. The non homogenous material showed separate particle boundaries and multiple depth of fields. The material had a surprising look of natural granite with flow and individual particle boundaries.

### Example 46

PLA was compounded at a temperature lower than the melting point of PLA (310 F) with 5% polysoy hydrogenated soybean oil from ADM that produced a flexible white biocopolymer with similar characteristics and look of polyethylene. The biocopolymer was compounded and cut into pellets. Secondly, ground cellulose paper insulation in a fluffy form was mixed while a water based paint was added. The fluffy cellulose converted into smaller particles with reasonable integrity. The particles were dried. The biocopolymer and colored composite particles where blended at a ration of 85% biocopolymer and 15% colored cellulosic particles then was extruded using low shear at a temperature below the melting point of PLA at 310 F. The resultant material maintained the individual particle look without blending it into a homogenous mixture creating a very high end Wok of natural three dimensional granite.

### Example 47

The clear PLA fractured random geometry particles are painted using metallic paint. The particles are fused in a mold at a heat below that of the PLA melting point wherein the particles become elastomeric and deform due to the materials low heat deflection point. The material is cooled. Initially you will see the painted surface of the particles that deformed on the surface and the material is mostly opaque in nature. By sanding or removing the surface layer at least the layer of the coating, we open up the clear particles and ONLY see the backside of the particles and the paint/clear PLA interface. By polishing the surface the material becomes very clear and we see the backside of each individual coated biocomposite or PLA particle. This provides a very unique optical property as compared to other forms of solid surfacing materials with a very good depth of field. By having random geometries within the clear-coated particle matrix, we also see various angles of reflections within each particle by their unique geometry. Thus every particle provides a unique optical property.

### Example 48

A plain kraft paper, then an biopolmer PLA extruded film (0.005″) is placed on top of the kraft. A second kraft is place on the top so that the PLA film is “sandwitched” between the unsaturated kraft paper. This alternating stack can be repeated to create thicker structures. The two layers of kraft with the biopolymer film between is then placed into a heated press at 350 degrees F. and pressure over 20 PSI and more preferable between 150 to 500 psi. Two stacked layers were prepared.

The first stack of alternating layers were placed in a press for 1 minute and removed. In breaking the final composite, the paper was not fully saturated or impregnated in which dry sections of paper were found. In addition the composite could be torn apart due to the low internal bond of the unsaturated papers.

The second stack of alternating layers were placed in the same press and same temperature extending the press time to 8 minutes. Once the composite was cooled, the layers were fully saturated and could not be torn. In cutting various layers with a knife, the kraft paper had darken due to the saturation of the PLA through the kraft also showing on the opposite side.

Both pieces were cut and sanded on their edges and inspected using a microscope. The first sample with the 1 minute cycle showed where the PLA was partically impregnating and saturating through the kraft, but not completely through whereas the second sample with the longer press time was completely saturating the paper layers.

Both pieces were also subjected to water emersion. The first sample pressed for 1 minute had very high absorption and swelling due to the non saturated kraft paper. The second sample look virtually water proof without swelling or surface roughness.

### Example 49

A second film using standard acrylic (0.005) was done replacing the PLA in which the Acyrlic film was between two layer of kraft paper. The stack was placed in a press under the same conditions above and for the full 8 minutes. The sample was removed and cooled. The material has no saturation and barely stuck the two layers together. The samples were easily pulled apart and had no strength nor stiffness.

To further illustrate, the following embodiments are here described:

1. A biolaminate composite assembly, comprising:
one or more biolaminate layers;
a non-plastic rigid substrate; and
an adhesive layer, in contact with the substrate and the one or more biolaminate layers;
wherein the one or more biolaminate layers is laminated to the substrate.

2. The biolaminate composite assembly of embodiment 1, wherein laminated comprises flat laminated.

3. The biolaminate composite assembly of embodiment 1, wherein a single biolaminate layer contacts a single side of the non-plastic rigid substrate.

4. The biolaminate composite assembly of embodiment 1, wherein two or more biolaminate layers contact two or more sides of the non-plastic rigid substrate.

5. The biolaminate composite structure of embodiment 2, wherein flat laminated comprises hot pressed, cold pressed, nip rolled, sheet form, full panel form, custom cut, or some combination thereof.

6. The biolaminate composite assembly of embodiment 1, wherein the adhesive comprises a glue line.

7. The biolaminate composite assembly of embodiment 1, wherein the adhesive layer comprises a heat activated adhesive.

8. The biolaminate composite assembly of embodiment 1, wherein the adhesive layer comprises a contact adhesive.

9. The biolaminate composite assembly of embodiment 1, wherein the adhesive layer comprises a cold press adhesive.

10. The biolaminate composite assembly of embodiment 9, wherein the adhesive layer comprises a pressure sensitive tape.

11. The biolaminate composite assembly of embodiment 1, wherein the substrate comprises a composite matrix.

12. The biolaminate composite assembly of embodiment 1, wherein the substrate comprises wood composite, MDF, HDF, plywood, OSB, wood particleboard, wood plastic composite, agrifiber plastic composite, agrifiber particleboard, agrifiber composite, gypsum board, sheet rock, hardboard, metal, glass, cement, cement board, cellulosic substrates, cellulose paper composites, multilayer cellulose glue composites, wood veneers, bamboo, recycled paper substrates or a combination thereof.

13. The biolaminate composite assembly of embodiment 1, wherein the substrate comprises substrates that are derived from agrifibers using a formaldehyde free matrix resin.

14. The biolaminate composite assembly of embodiment 1, wherein biolaminate composite assembly comprises work surfaces, shelving, millwork, laminated flooring, countertops, tabletops, furniture components, store fixtures, dividers, wall coverings, cabinet coverings, cabinet doors, passageway doors or combinations thereof.

15. The biolaminate composite, assembly of embodiment 1, wherein the one or more biolaminate layers comprises a thickness of about 0.005 to about 0.25″.

16. A biolaminate composite assembly of embodiment 15, wherein two or more of the one or more biolaminate surface layers are thermally fused together by heat fusion or an adhesive.

17. The biolaminate composite assembly of embodiment 1, wherein the biolaminate composite assembly comprises a thickness of about 0.050″ to about 1.5″.

18. The biolaminate composite assembly of embodiment 1, wherein one or more biolaminate layers comprise PLA, PHA or a combination thereof.

19. The biolaminate composite assembly of embodiment 1, wherein one or more biolaminate layers comprise bioplastics, biopolymers, modified biopolymer, biocomposite or a combination thereof.

20. A biolaminate composite assembly of embodiment 19, wherein bioplastic, biopolymer, modified biopolymer, and a biocomposite comprises polylactic acid base material.

21. The biolaminate composite assembly of embodiment 1, wherein one or more biolaminate layers comprise a modified PLA in combination with one or more of a plastic, bioplastic, additive or bioadditives.

22. The biolaminate composite assembly of embodiment 1, wherein one or more biolaminate layers comprise a modified PLA in combination with one or more of a filler, fiber or colorant.

23. The biolaminate composite assembly of embodiment 1, further comprising one or more print layers.

24. The biolaminate composite assembly of embodiment 23, wherein the print layers are positioned on a top surface of the one or more biolaminate layers, a bottom surface of the one or more biolaminate layers or in between the one or more biolaminate layers.

25. The biolaminate composite assembly of embodiment 1, wherein the one or more biolaminate layers further comprise bioplasticizers, biolubricants or both.

26. The biolaminate composite assembly of embodiment 25, wherein bioplasticizers comprise citric esters, esters, lactic acid, and other forms of biobased plasticizer.

27. The biolaminate composite assembly of embodiment 25, wherein biolubricants comprise natural waxes, lignants or a combination thereof.

28. The biolaminate composite assembly of embodiment 1, wherein the one or biolaminate layers comprise a flexibility comparable to that of a flexible PVC layer.

29. The biolaminate composite assembly of embodiment 1, further comprising one or more decorative additives.

30. The biolaminate composite assembly of embodiment 29, wherein the one or more decorative additives include a colorant, texture, decorative particles, decorative flakes or natural impregnated fibers.

31. The biolaminate composite assembly of embodiment 30 wherein the colorant allows for a natural depth of field providing a three dimensional aesthetic value.

32. The biolaminate composite assembly of embodiment 1, further comprising functional additives.

33. The biolaminate composite assembly of embodiment 32, wherein the functional additives include EVA, FR, natural quartz, bioplasticizers, biolubricants, minerals, natural fibers, synthetic fibers, impact modifiers, antimicrobial, conductive fillers, or a combination thereof.

34. The biolaminate composite assembly of embodiment 1, wherein the one or more biolaminate layers comprise a rolled or pressed textured surface.

35. The biolaminate composite assembly of embodiment 1, furthering comprising a non-plastic rigid substrate in contact with a second side of the one or more biolaminate layers.

36. The biolaminate composite assembly of embodiment 1, further comprising a bioplastic edgebanding.

37. The biolaminate composite assembly of embodiment 1, wherein the one or more biolaminate layers comprise edgebanding.

38. The biolaminate composite assembly of embodiment 1, wherein the non-plastic rigid substrate comprises biobased edgebanding and biolaminate surfaces.

39. The biolaminate composite assembly of embodiment 38, wherein both the one or more biolaminate layers and edgebanding comprise PLA, modified PLA or both.

40. The biolaminate composite assembly of embodiment 1, wherein the lamination is done using a hot press process, roll lamination, cold press process, or utilizing contact adhesives.

41. The biolaminate composite assembly of embodiment 1, further comprising a fire retardant.

42. The biolaminate composite assembly of embodiment 1, wherein the one or more biolaminate layers further comprise natural minerals.

43. The biolaminate composite assembly of embodiment 1, wherein the biolaminate composite structure comprises a three dimensional appearance.

44. A biolaminate composite assembly, comprising:
one or more biolaminate layers;
a three-dimensional non-plastic rigid substrate; and
an adhesive layer, in contact with the substrate and the one or more biolaminate layers;
wherein the one or more biolaminate layers is thermoformed to two or more surfaces of the substrate.

45. The biolaminate composite assembly of embodiment 44, wherein thermoforming is permanent.

46. The biolaminate composite assembly of embodiment 44, wherein thermoformed comprises vacuum forming, linear forming or a combination thereof.

47. The biolaminate composite assembly of embodiment 44, wherein the adhesive layer comprises a glue fine.

48. The biolaminate composite assembly of embodiment 44, wherein the substrate comprises a composite matrix.

49. The biolaminate composite assembly of embodiment 44, wherein the substrate comprises wood composite, MDF, HDF, plywood, OSB, wood particleboard, wood plastic composite, agrifiber plastic composite, agrifiber particleboard, agrifiber composite, gypsum board, sheet rock, hardboard, metal, glass, cement, cement board, cellulosic substrates, cellulose paper composites, multilayer cellulose glue composites, wood veneers, bamboo, recycled paper substrates or a combination thereof.

50. The biolaminate composite assembly of embodiment 44, wherein the substrate comprises substrates that are derived from agrifibers using a formaldehyde free matrix resin.

51. The biolaminate composite assembly of embodiment 44, wherein biolaminate composite assembly comprises work surfaces, shelving, millwork, flooring, countertops, tables, dividers, wall coverings, cabinet coverings, cabinet doors, store fixture components, passageway doors or combinations thereof.

52. The biolaminate composite assembly of embodiment 44, wherein the one or more biolaminate layers comprises a thickness of about 0.005 to about 0.25″.

53. The biolaminate composite assembly of embodiment 44, wherein the biolaminate composite assembly comprises a thickness of about 0.030″ to about 1.5″.

54. The biolaminate composite assembly of embodiment 44, wherein one or more biolaminate layers comprises PLA, PHA and other bioplastics/biopolymers.

55. The biolaminate composite assembly of embodiment 44, further comprising bioplasticizers and biolubricants.

56. The biolaminate composite assembly of embodiment 44, further comprising one or more decorative additives.

57. The biolaminate composite assembly of embodiment 56, wherein the one or more decorative additives include a colorant, texture, decorative particles, decorative flakes or natural impregnated fibers.

58. The biolaminate composite assembly of embodiment 57 wherein the colorant allows for a natural depth of field providing a three dimensional aesthetic value.

59. The biolaminate composite assembly of embodiment 44, further comprising functional additives.

60. The biolaminate composite assembly of embodiment 59, wherein the functional additives include EVA, FR, natural quartz, bioplasticizers, biolubricants, minerals, fibers, synthetic fibers or a combination thereof.

61. The biolaminate composite assembly of embodiment 44, wherein the biolaminate composite structure comprises a rolled or pressed textured surface.

62. The biolaminate composite assembly of embodiment 44, furthering comprising a non-plastic rigid substrate in contact with a second side of the one or more biolaminate layers.

63. The biolaminate composite assembly of embodiment 44, further comprising a fire retardant.

64. The biolaminate composite assembly of embodiment 44, further comprising natural minerals.

65. The biolaminate composite assembly of embodiment 64, wherein natural minerals comprise minerals meeting high wear resistant HPL standards.

66. The biolaminate composite assembly of embodiment 44, wherein the biolaminate composite structure comprises a three dimensional appearance.

67. A method for making a biolaminate composite assembly, comprising: laminating one or more biolaminate layers to a non-plastic rigid substrate.

68. The method of embodiment 67, further comprising reverse printing on the one or more biolaminate layers.

69. The method of embodiment 67, wherein the one or more biolaminate layers is clear or transparent.

70. The method of embodiment 67, further comprising direct printing to the one or more biolaminate layers.

71. The method of embodiment 67, further comprising multilayer printing to the one or more biolaminate layers:

72. The method of embodiment 67, further comprising printing a decorative print layer between two or more of the biolaminate layers.

73. The method of embodiment 72, further comprising thermally fusing two or more biolaminate layers together.

74. The method of embodiment 67, further comprising printing a decorative layer to the one or more biolaminate layers.

75. The method of embodiment 74, wherein printing comprises offset printing, inkjet printing, screen printing or flexographic printing.

76. The method of embodiment 74, wherein printing utilizes a bioink.

77. The method of embodiment 67, further comprising applying a clear liquid coating to the one or more biolaminate layers.

78. The method of embodiment 77, wherein applying comprises spraying, rolling, offset printing, or rod coating method.

79. The method of embodiment 67, wherein the one or more biolaminate layers comprises a clear top layer, a decorative interior layer and an opaque layer, each layer thermally fused to the adjacent layer.

80. The method of embodiment 70, further comprising applying a clear coating on an outer surface of the printed one or more biolaminate layers.

81. A method for making a biolaminate composite assembly, comprising:

thermoforming one or more biolaminate layers to a non-plastic rigid substrate.

82. The method of embodiment 81, wherein forming comprises thermoforming, vacuum forming, thermoforming or a combination thereof.

83. The method of embodiment 81, further comprising reverse printing on the one or more biolaminate layers.

84. The method of embodiment 81, wherein the one or more biolaminate layers is clear or transparent.

85. The method of embodiment 81, further comprising direct printing to the one or more biolaminate layers.

86. The method of embodiment 81, further comprising multilayer printing to the one or more biolaminate layers.

87. The method of embodiment 81, further comprising printing a decorative print layer between two or more of the biolaminate layers.

88. The method of embodiment 87, further comprising thermally fusing two or more biolaminate layers together.

89. The method of embodiment 88, further comprising printing a decorative layer to the one or more biolaminate layers.

90. The method of embodiment 89, wherein printing comprises offset printing, inkjet printing, screen printing or flexographic printing.

91. The method of embodiment 89, wherein printing utilizes a bioink.

92. The method of embodiment 81, further comprising applying a clear liquid coating to the one or more biolaminate layers.

93. The method of embodiment 92, wherein applying comprises spraying, rolling, offset printing, or rod coating method

94. The method of embodiment 81, wherein the one or more biolaminate layers comprises a clear top layer, a decorative interior layer and an opaque inner layer, each layer thermally fused to the adjacent layer.

95. The method of embodiment 85, further comprising applying a clear coating on an outer surface of the printed one or more biolaminate layers.

96. A decorative biolaminate layer, comprising:
a clear biopolymer layer;
an opaque biopolymer layer; and
a decorative print layer;
wherein the print layer is positioned between the clear layer and opaque layer.

97. he decorative biolaminate layer of embodiment 96, wherein the clear biopolymer layer is textured.

98. The decorative biolaminate layer of embodiment 96, wherein positioned comprises fused.

1. A biolaminate composite assembly, comprising:
one or more biolaminate layers;
a rigid non-plastic substrate; and
a colored layer; positioned between the one or more biolaminate layers and substrate;
wherein the one or more biolaminate layers is laminated to the substrate.

2. The biolaminate composite assembly of claim 1, further comprising an adhesive layer, in contact with at least one of the substrate, colored layer and the one or more biolaminate layers;

3. The biolaminate composite assembly of claim 1, wherein two or more biolaminate layers contact two or more sides of the substrate.

4. The biolaminate composite assembly of claim 1, wherein biolaminate composite assembly comprises work surfaces, shelving, millwork, laminated flooring, countertops, tabletops, furniture components, store fixtures, dividers, wall coverings, cabinet coverings, cabinet doors, passageway doors or combinations thereof.

5. The biolaminate composite assembly of claim 1, wherein one or more biolaminate layers comprise PLA, PHA or a combination thereof.

6. The biolaminate composite assembly of claim 1, further comprising a backer layer.

7. The biolaminate composite assembly of claim 6, wherein the backer layer is, positioned between the colored layer and substrate.

8. The biolaminate composite assembly of claim 1, wherein the colored layer comprises a latex paint.

9. The biolaminate composite assembly of claim 1, wherein the one or more biolaminate layers is clear or semi-transparent.

10. A decorative biolaminate assembly, comprising:
one or more thin biolaminate films;
a rigid non-plastic substrate;
a colored layer; in contact with the substrate and the one or more biolaminate films; and
a backer layer, positioned between substrate and colored layer; wherein the one or more biolaminate films is laminated to the substrate.

11. A decorative biolaminate assembly, comprising:
decorative biocomposite particles dispersed on or in a biopolymer matrix, wherein the decorative biocomposite particles comprise flocculent fiber particles.

12. The decorative biolaminate assembly of claim 11, wherein the biopolymer matrix includes a cellulosic layer.

13. The decorative biolaminate assembly of claim 11, further comprising a layer of hydrogenated vegetable oil over the decorative biocomposite particles.

14. The decorative biolaminate assembly of claim 11, wherein the decorative biocomposite particles are coated.

15. A biolaminate composite assembly, comprising:
one or more biolaminate layers;
a high performance surface layer;
a substrate; and
an adhesive layer, in contact with the substrate and the one or more biolaminate layers;
wherein the one or more biolaminate layers is laminated to the substrate.

16. A linear extruded biocomposite assembly comprising:
a decorative biolaminate; and
a biocomposite extruded substrate;
wherein the decorative biolaminate is provided over the biocomposite extruded substrate.

17. A biolaminate composite assembly, comprising:
one or more biolaminate layers;
a veneer substrate; and
an adhesive layer, in contact with the substrate and the one or more biolaminate layers;
wherein the one or more biolaminate layers is laminated to the substrate.

18. The biolaminate composite assembly of claim 17, wherein two or more biolaminate layers contact two or more sides of the veneer substrate.

19. The biolaminate composite assembly of claim 17, wherein the substrate comprises wood or a wood composite.

20. The biolaminate composite assembly of claim 17, wherein biolaminate composite assembly comprises work surfaces, shelving, millwork, laminated flooring, countertops, tabletops, furniture components, store fixtures, dividers, wall coverings, cabinet coverings, cabinet doors, passageway doors or combinations thereof.

21. The biolaminate composite assembly of claim 17, wherein one or more biolaminate layers comprise PLA, PHA or a combination thereof.

22. A decorative veneer biolaminate assembly, comprising:
one or more thin biolaminate films;
a veneer substrate;
a clear adhesive layer, in contact with the substrate and the one or more biolaminate films; and
a backer layer, positioned on an underside of the veneer substrate;
wherein the one or more biolaminate films is laminated to the substrate.

23. The assembly of claim 22, wherein the backer layer comprises a saturated paper, a rubber sheet or composite rubber sheet.

24. A structural biolaminate panel assembly, comprising:
one or more bioplastic layers, laminated to form a substrate core one or more face sheets, in contact with the one or more bioplastic layers.
